(19) United States
(12) Patent Application Publication
(10) Pub. No.: US 2002/0186330 A1
(43) Pub. Date: Dec. 12, 2002

(54) Liquid crystal display and production method of the same

(76) Inventor: Kiyohiro Kawasaki, Hirakata-shi (JP)

Correspondence Address: Parkhurst & Wendel, 1421 Prince Street Suite 210, Alexandria, VA, 22314-2805, US

(21) Appl. No.: 09/958,076

(22) PCT Filed: Feb. 5, 2001
(86) PCT No.: PCT/JP01/00805

(30) Foreign Application Priority Data
Feb. 4, 2000 (JP) 2000-027457
Jun. 13, 2000 (JP) 2000-176435

(51) Int. Cl. G02F 1/136

(52) U.S. Cl. 349/43

(57) ABSTRACT

In the channel etched TFT 5-mask process, an excessive etching is generated over the drain electrode at the stage of forming an opening. Also, in the passivation insulating layer forming process, the characteristic of the transistor is deteriorated with ease. In addition, the production process is so long that the process cost cannot be reduced.

To solve these disadvantages, the source wire and the drain wire are formed of a lamination of an anodizable, heat-resistant metal and an aluminum alloy and their surfaces are anodized, and also the amorphous silicon layer containing impurities is changed to the silicon oxide layer through the use of a photo-mask, thereby eliminating the need of the passivation insulating layer. In addition, an additional insulating layer is formed on the exposed scan line, thereby streamlining the island-shaped semiconductor forming process and the process of forming the opening in the insulating layer.

### TECHNICAL FIELD

This invention relates to an image display device using liquid crystal, and more particularly, to an insulated gate transistor for an active liquid crystal (image) display.

### BACKGROUD ART

### General Background Art of the Invention

With a progress of a microfabrication technology, a liquid crystal material technology and a high density package technology in recent years, a variety of TV receiver sets or image display equipments with 5-50 cm diagonal liquid crystal panels are now being commercially provided in large quantities. Also, color displays have easily been actualized by colored layers of red (R), green (G) and blue (B) being formed on one of two glass substrates forming the liquid crystal panels. Particularly, the so-called active liquid crystal panel having a switching element built-in for each pixel surely provides an image having a little cross talk (or non-cross talk), a quick response and a high contrast ratio.

These liquid crystal image displays (liquid crystal panels) are generally formed into matrix of about 200-1,200 scan lines x about 200-1,600 signal wires. Recently, an increased screen size and an increased fineness are being both promoted simultaneously to meet an increased display capacity.

In FIG. 1, there is shown the package in the liquid crystal panel. In this diagram, electrical signals are supplied to an image display portion via packaging means, such as a COG (Chip-On-Glass) method in which a semiconductor integrated circuit chip 3 for supplying driving signals to a group of electrode terminals 6 of the scan lines formed, for example, on a glass substrate 2 which is one of two transparent insulating substrates forming the liquid crystal panel 1 is connected by use of an conductive adhesive, or a TCP (Tape-Carrier-Package) method in which, for example, a polyimide-resin-based thin film is used as a base, and a TCP film 4 having a golded or soldered copper foil terminals (not shown) is press-contacted with a group of electrode terminals 5 of the signal wires and fixed thereto by use of adequate adhesive containing conductive media. It is to be noted that, for convenience of explanation, the two different packaging methods are both illustrated in the diagram but, actually, either of the two methods is properly selected.

7, 8 denote wiring passages for connecting between the image display portion located in a generally center portion of the liquid crystal panel 1 and the electrode terminals 5, 6 of the signal wires and scan lines. These are not necessarily formed of the same conductive material as those of the electrode terminals 5, 6. 9 is an opposite glass substrate which is the other transparent insulating substrate having, on its opposite surface, transparent conductive opposing electrodes common to all liquid crystal cells or a color filter (a substrate with a color filter).

FIG. 2 shows an equivalent circuit diagram of the active liquid crystal panel in which an insulated gate transistor 10 is arranged as the switching element for each pixel. In this diagram, 11 (8 in FIG. 1) denotes a scan line, 12 (7 in FIG. 1) denotes a signal wire, and 13 denotes a liquid crystal cell. The liquid crystal cell is electrically treated as a capacitance element. The elements depicted by solid lines are formed on the one glass substrate 2 of the liquid crystal panel, and an opposing electrode 14 common to all liquid crystal cells 13 depicted by dotted lines are formed on the other glass substrate 9. When an OFF resistance of the insulated gate transistor 10 or a resistance of the liquid crystal cell 13 is low or when a greater importance is given to a gray scale of a display image, some circuit device is added, such as, for example adding an auxiliary storage capacity 15 for increasing a time constant of the liquid crystal cell 13 as a load in parallel to the liquid crystal cell 13. 16 denotes a storage capacity line that is a common bus of the storage capacity 15.

FIG. 3 shows a sectional view of a principal part of the image display portion of the liquid crystal panel. The two glass substrates 2, 9 forming the liquid crystal panel 1 are spaced apart at a predetermined distance of the order of about 5 or 6 micrometers by means of spacer material (not shown) such as resin fibers or beads. The gap therebetween is formed as a closed space sealed by a sealing material and a sealer comprising an organic resin (neither is shown) applied to a marginal portion of the glass substrate 9. The liquid crystal 17 is packed in the closed space.

For providing a color display, an organic thin film of the order of 1-2 μm in thickness containing either colorant or pigment or both of them, which is called a colored layer (color filter) 18, is made to adhere to the glass substrate 9 on a closed space side thereof, to provide the color display capability for the glass substrate. In this case, the glass substrate 9 is called a color filter (which is sometimes abbreviated to CF). Depending on the behavior of the liquid crystal material 17, a polarizing plate 19 is made to adhere to either a top surface of the glass substrate 9 or a bottom surface of the glass substrate 2 or both of them, so that the liquid crystal panel 1 functions as an electro-optic device for each pixel. A very large proportion of currently commercially-available liquid crystal panels use TN (Twist Nematic) -based material as the liquid crystal material and usually involves two polarizing plates 19. Further, in the transmission liquid crystal panel as illustrated in this diagram, a backside light source is disposed as a light source, though not shown, so that the panel can be irradiated with white light from the bottom.

Thin polyimide resin films 20 having thickness of the order of e.g. 0.1 μm, which are formed on the two glass substrates 2, 9 to be in contact with the liquid crystal 17, are alignment layers used for aligning the liquid crystal molecules in a predetermined direction. 21 denotes a drain electrode (wiring) for connecting between a drain of the insulated gate transistor 10 and a transparent conductive pixel electrode 22. The drain electrode is often formed simultaneously with the signal wire (source wire) 12. Located between the signal wire 12 and the drain electrode 21 is a semiconductor layer 23. The details thereon will be given later. Thin Cr film layers 24 having thickness of the order of 0.1 μm formed on the color filter 9 at the boundary between the adjoining colored layers 18 are light shields to prevent outside light from being incident on the semiconductor layer 23, the scan line 11 and the signal wire 12, which is an established technology as the so-called Black Matrix (which is sometimes abbreviated to BM).

The insulated gate transistor is usually adopted as a switching element for a pixel portion. Description on the structure of the insulated gate transistor and the producing method will be given below. While two types of insulated gate transistor are now in heavy use, one of them is introduced here as a prior art (which is called the etch stop type). FIG. 4 is a plan view of a unit pixel of an active substrate forming the conventional liquid crystal panel (a semiconductor device for image display). FIG. 5 shows the variation of the structure in section taken along line A-A′ of this diagram with the development. In the following, the production processes are described briefly, centering on FIG. 5. The storage capacity 15 of FIG. 2 is formed by a region 51 (a downward-sloping shaded area) where a projected portion 50 formed on the scan line 11 and the pixel electrode 22 are overlapped through the gate insulating layer, though the detailed description thereon is omitted here.

First, as shown in FIG. 5(a), e.g. Cr, Ta (tantalum), Mo (molybdenum) or alloys or silisides (silicon compounds) thereof is made to adhere to one primary surface of the glass substrate 2 having thickness of the order of 0.5-1.1 mm, which is an insulative substrate high in heat resistance, chemical resistance and transparency, such as a glass substrate 1737, brand name, commercially available from Corning, Inc., by use of a vacuum film forming device, such as SPT (sputtering system), whereby the gate electrode 11 which serves as the scan line as well is selectively formed thereon in the form of a first metal film having thickness of the order of 0.1-0.3 μm by use of the microfabrication technology. The material of the scan line may be selected from comprehensive consideration of heat resistance, chemical resistance, hydrofluoric acid resistance and conductivity.

To reduce a resisting value of the scan line so as to meet the big screen of the liquid crystal panel, AL (aluminum) is used as the material of the scan line. AL is low in heat resistance by itself, so that it is in general combined with a heat resisting metal, such as Cr. Ta, Mo or silisides thereof, so that a laminated layer is formed or a layer of oxides (AL₂O₃) is added on a surface of AL by anodic oxidation, which is a general technique at present. In other words, the scan line 11 comprises at least one metal layer.

Then, as shown in FIG. 21(b), three thin film layers comprising a first SiNₓ (silicon nitride) layer 30 to form the gate insulating layer, a first amorphous silicon (a-Si) layer 36 containing almost no impurities to form a channel of the insulated gate transistor, and a second SiNₓ layer 32 to form an insulating layer to protect the channel are made to adhere to the entire area of the glass substrate 2 in order, to have thickness of e.g. 0.3 μm, 0.05 μm and 0.1 μm, respectively, by use of the PCVD (Plasma CVD) device.

When the gate insulating layer 30 is formed, a yield rate improving measure is often taken as a know-how-like technique,,such as, for example layering with another insulating layer (e.g. TaOₓ or SiO₂, or AL₂O₃ mentioned above), or forming the SiNₓ layer in two separate stages and taking a cleansing process between those stages. The gate insulating layer is not necessarily limited to a single material or a single layer.

Sequentially, the second SiNₓ layer on the gate electrode 11 is processed by use of the microfabrication technology so that it can selectively be left with a width narrower than the gate electrode 11 to after the second amorphous silicon layer 33 containing e.g. phosphor as the impurity is made to adhere to the entire area to have thickness of the order of 0.51 μm by use of the PCVD device, the first amorphous silicon layer 31 and the second amorphous silicon layer 33 are processed to leave in the form of island (semiconductor part of TFT) shaped layers 31′, 33′ so that they can be located only in the neighborhood of and over the gate electrode 11, to expose the gate insulating layer 30, as shown in FIG. 21(c).

Sequentially, as shown in (d), for example ITO (Indium-Tin-Oxide) is made to adhere to it in the form of the transparent conductive layer having thickness of the order of 0.1-0.2 μm by use of the vacuum film forming device, such as SPT, and then the pixel electrode 22 is formed selectively (in a necessary region only) on the gate insulating layer 30 by use of the microfabrication technology.

Further, as shown in (e), an opening 63 necessary for electrical connection is formed selectively on the gate insulating layer 30 located over the scan line 11 around the image display portion. Thereafter, as shown in FIG. 21(f), a heat-resistant, thin metal film layer 34 made of e.g. Ti, Cr and Mo and a thin AL film layer 35 having thickness of the order of 0.3 μm are made to adhere in order in the form of a heat-resistant thin metal layer having thickness of the order of 0.1 μm and a low resistance wiring layer, respectively, by use of the vacuum film forming device such as SPT, whereby the source wire 12, which comprises a lamination of a heat-resistant thin metal layer 34′ and a low resistance wiring layer 35′ and serves as the drain wire 21 and the signal wire of the transistor as well, with the inclusion of the pixel electrode 22, is selectively formed thereon by use of the microfabrication technology.

With a photosensitive resin pattern used for this selective patterning as a mask, the second amorphous silicon layer 33′ between the source/drain wires 12, 21 is removed to expose the second SiNₓ layer 32′ and the first amorphous silicon layer 31′ is removed from the remaining region to expose the gate insulating layer 30. This process is called the etch stop, because the etching of the second amorphous silicon layer 33′ is automatically stopped by the provision of the second SiNₓ layer 32′ which is a protective layer of the channel.

The source/drain electrodes 12, 21 are formed in the condition in which they are partly overlapped with the gate electrode 11 in a plane (about 5-6 μm), so as to avoid any offset structure of the insulated gate transistor.

Since the overlapped portion serves electrically as a parasitic capacitance, the overlap preferably has a smallest possible area. The degree of overlap is determined by overlapping accuracy of an exposure, masking accuracy, a coefficient of expansion of the glass substrate, and temperature of the glass substrate when exposed to light. A practical value of the overlap is the order of 2 μm at most. The wiring passage 8 is formed around the image display portion, to connect between the signal wire 12 including the opening 63 over the scan line 11, and the electrode terminal 6 on the scan line side or between the scan line 11 and the electrode terminals 6 on the scan line side, which is also a general pattern design.

Finally, as is the case with the gate insulating layer 30, the SiNₓ layer having thickness of the order of 0.3-0.7 μm is made to adhere to the entire area of the glass substrate 2 in the form of the transparent insulating layer by use of the PCVD device, to form a passivation insulating layer 37. Thereafter, an opening 38 is formed over the pixel electrode 22 to expose a large part of the pixel electrode 22, as shown in FIG. 5(g), then concluding the production process of the active substrate. In this stage, openings are also formed over the electrode terminal 6 of the scan line and the electrode terminal 5 of the signal wire (FIG. 1), respectively, to expose a large part of the electrode terminals.

If the wiring resistance of the signal wire 12 does not matter, the low resistance wiring layer 35 made of AL is not necessarily needed. In this case, the source/drain wirings 12, 21 can be formed as a single layer by adequately selecting the heat-resistant metal material such as Cr, Ta and Mo. The heat resistance of the insulated gate transistor is described by the prior art document of Japanese Laid-open (Unexamined) Patent Publication No. Hei 7(1995)-74368.

The passivation insulating layer 37 on the pixel electrode 22 is removed with two aims. One is to prevent reduction of an effective voltage applied to the liquid crystal cell Another is to avoid image persistance caused by the electric charge accumulated in the passivation insulating layer 37 which is generally poor in quality This is because since the heat resistance of the insulated gate transistor is not so high, the film forming temperature of the passivation insulating layer 37 is lower than that of the gate insulating layer 30 by a few tens of degrees centigrade and, therefore, the passivation insulating layer is obliged to be a low temperature film of not more than 250° C.

The production process of the active substrate mentioned above requires seven photo-lithography processes, which is substantially a standard production process called the 7-mask process. It is an important objective for liquid crystal panel manufactures to reduce the number of production processes, for achieving price-reduction of the liquid crystal panel to meet further increasing demands. For this, the so-called 5-mask process streamlined by use of the channel etched transistor has been established recently.

FIG. 6 is a plan view of the unit pixel of the active substrate designed for the 5 mask. Variation of the active substrate with the production processes is shown in FIG. 7, depicted in section taking along line A-A′ of FIG. 6. In the following, the production processes are described briefly. The storage capacity 15 is formed by a region 52 (a downward-sloping shaded area) where the storage capacity line 16 and the drain wire 21 are overlapped through the gate insulating layer, though the detailed description thereon is omitted here.

First, as is the case with the prior art, a heat-resistant thin metal layer having thickness of the order of 0.1-0.3 μm is made to adhere to one primary surface of the glass substrate 2 by use of the vacuum film forming device, such as SPT (sputtering system), whereby the gate electrode 11 and the storage capacity line 16 which serves as the scan line as well is selectively formed thereon by use of the microfabrication technology, as shown in FIG. 7(a).

Then, as shown in FIG. (b), three thin film layers comprising the first SiNₓ (silicon nitride) layer 30 to form the gate insulating layer, the first amorphous silicon layer 31 containing almost no impurities to form the channel of the insulated gate transistor, and the second silicon layer 33 to form the source/drain of the insulated gate transistor are made to adhere to the entire area of the glass substrate 2 in order, to have thickness of e.g. 0.3 μm, 0.2 μm and 0.05 μm, respectively, by use of the PCDV device.

Then, as shown in FIG. (c), the semiconductor layer comprising the first and second amorphous silicon layers formed on the gate electrode 11 are processed to leave in the form of island shaped layers 31′, 33′, to expose the gate insulating layer 30.

Sequentially, as shown in FIG. (d), the thin film layer 34 made of e.g. Ti, the thin AL film layer 35, and the thin film layer 36 made of e.g Ti are made to adhere to those layers in order in the form of the heat-resistant metal layer having thickness of the order of 0.1 μm, the low resistance wire layer having thickness of the order of 0.3 μm, and the intermediate conductive layer having thickness of the order of 0.1 μm, respectively, by use of the vacuum film forming device, such as SPT. Then, the source wire 12 that serves as the drain wire 21 and the signal wire of the insulated gate transistor as well is formed selectively by use of the microfabrication technology. With the photosensitive resin pattern used for the source/drain wire as the mask, this selective pattern is formed by etching the thin Ti film layer 36, the thin AL film layer 35, the thin Ti film layer 34, the second amorphous silicon layer 33′, and the first amorphous silicon layer 31′ are etched in order. In this process, the first amorphous silicon layer 31′ is etched with about 0.05-0.1 μm left, differently from the process of FIG. 5(e). Because of this, this process is called a channel etch.

The source wire 12 and the drain wire 21 are each formed with complexity of a three-layer. This is because the thin Ti film layer 36 of the intermediate conductive layer is interposed between those two layers, because when ITO of the transparent conductive layer and the thin AL film layer 35 of the low resistance wire layer are in direct contact with each other, an electric corrosion reaction is caused by alkali developing solution and a resist peeling solution, to vanish their electrodes.

Further, after the photosensitive resin pattern is removed, the SiNₓ layer having thickness of the order of 0.3 μm is made to adhere onto the entire area of the glass substrate 2 in the form of the transparent insulating layer by use of the PCVD, as is the case with the gate insulating layer, to form the passivation insulating layer 37. Thereafter, a first opening 62 and a second opening 63 are formed on the location where the drain electrode 21 is formed and the location where the electrode terminal 6 of the scan line 11 is formed, respectively, to expose a part of the scan line 11, as shown in FIG. (e). A third opening is also formed on the location where the electrode terminal 5 of the signal wire is formed, to expose a part of the signal wire 12, though not shown.

Finally, as shown in FIG. (f), for example ITO (Indium-Tin-Oxide) is made to adhere in the form of the transparent conductive layer having thickness of the order of 0.1-0.2 μm by use of the vacuum film forming device, such as SPT, and then the pixel electrode 22 is selectively formed with the inclusion of the drain wire 21 in the first opening 62 on the passivation insulating layer 37 by use of the microfabrication technology, to complete the active substrate 2. A part of the scan line 11 exposed in the second opening 63 may be used as the electrode terminal 6. The electrode terminal 6′ comprising ITO may selectively be formed with the inclusion of the second opening 63 on the,passivation insulating layer 37, as illustrated.

Thus, the 5-mask process can eliminate the two photo-lithography processes by streamlining the contact forming process and the island-shaped semiconductor layer forming process. Also, since the pixel electrode 22 is located on the uppermost layer of the active substrate 2, if the active substrate is made to have an increased thickness of e.g. 1.5 μm or more by using a thin film of transparent resin in addition to the passivation insulating layer 37, that will provide the advantageous results that even when the pixel electrode 22 is overlapped with the scan line 11 or the signal wire 12, little interference is caused by the electrostatic capacity, so that the degradation of the picture quality is avoided, thus enabling the pixel electrode 22 to increase in size, so as to provide an improved aperture ratio.

### BACKGROUND ART PARTICULARLY PERTINENT TO THE OBJECTIVE TO BE SOLVED BY THE INVENTION

In the 5-mask process, the process of forming the contact to the drain wire and the process of forming the contact to the scan line are taken simultaneously, for the reason of which the insulating layers in the openings 62, 63 corresponding to the drain wire and the scan line have to be varied in thickness and form. As already mentioned, the passivation insulating layer 37 is poor in film quality, as compared with the gate insulating layer 30, so that when the etching is performed by using the hydrofluoric-acid-based etching solution, those layers are etched at different etching speeds of a few thousands of Å per min. and a few hundreds of Å per min. that are different by an order of magnitude. The sectional form of the first opening 62 located over the drain wire 21 is etched so excessively at the top that the hole diameter cannot be controlled. For this reason, the dry etching using a fluorochemical gas is obliged to be employed.

However, even when the dry etching is employed, since the first opening 62 over the drain wire 21 is formed in the passivation insulating layer 37 only, it is unavoidable that the first opening 62 is etched excessively, as compared with the second opening 63 over the scan line 11. As a result, the intermediate conductive layer 36′ is reduced in film thickness by the etching gas.

Also, when the photosensitive resin pattern is removed after completion of the etching, it is common that a surface of the photosensitive resin pattern is peeled off by about 0.1-0.3 μm in the process of oxygen plasma ashing, in order to remove polymer on the fluorinated surface, first, and then is treated with drug solution using an organic peeling solution, such as a peeling solution 106 available from Tokyo Ohka Kogyo Co., Ltd.. When the film thickness of the intermediate conductive layer 36′ is reduced so much that the aluminum layer 35′ of the base is brought into the exposed state, an insulating material of AL₂O₃ is formed on the aluminum layer 35′ in the process of oxygen plasma ashing, so that the ohmic contact that forms the ormic voltage-current property can no longer be provided between the intermediate conductive layer and the pixel electrode 22. In order to escape from this problem, the film thickness of the intermediate conductive layer 36′ is, in general, preset to have an increased thickness of 0.2 μm from the beginning in preparation for the reduction of the film thickness of the intermediate conductive layer 36′.

However, when these thin films in the substrate are poor in in-plane uniformity of quality, this approach does not always operate effectively. The same applies to the case where the thin films in the substrate are poor in in-plane uniformity of the etching speed. In any case, it is difficult for the surface of the scan line 11 and the surface of the drain wire 23 which are exposed in the openings 62, 63 to escape from the problems of the reduction in film thickness caused by the etching gas and the oxidation caused by the oxygen gas plasma.

Although the passivation insulating layer is adopted in the streamlined 5-mask process as well, for passivation of the source wire and the drain wire, since the passivation insulating layer 37 is lower in film forming temperature than the gate insulating layer 30 by about 50 or 60° C. of centigrade from its relationship with the heat resistance of the insulated gate transistor, it is unavoidable that the passive insulating layer comes to have some influence even when it is formed in the film forming process under low temperature of 250° C. or less. Particularly, it is unavoidable that the ON current is reduced by the order of 10-30%. With the increase in wire resistance, the decrease in current drivability of the insulated gate transistor is caused, which in turn forms a great hindrance for achieving the big-screen and high-fineness liquid crystal panel.

In addition, in the channel-etched, insulated gate transistor, the first amorphous silicon layer containing no impurities in the channel region must be made to adhere heavily (usually 0.2 μm in thickness for the channel-etched type). If not, the first amorphous silicon layer is largely affected by the in-plane uniformity of the glass substrate, so that the characteristic of the transistor is inclined to have irregularity. This correlates with a capacity operating rate of PCVD and a generation rate of particle to a large extent and this is a very critical matter from the viewpoint of production cost as well.

In the circumstances, a passivation layer forming technology capable of avoiding the disadvantages involved in the contact forming process and also compensating low heat resistance of the insulated gate transistor is being sought.

In addition, further reduction of the number of production processes is being desired for achieving price-reduction of the liquid crystal panel to meet further increasing demands.

### SUMMARY OF THE INVENTION

According to the present invention, the technique of converting a semiconductor layer containing impurities to a silicon oxide layer in an anodic oxidation method, to provide a channel protecting layer for the insulated gate transistor, as disclosed by the prior art document of Japanese Laid-open Patent Publication No. Hei 4(1992)-302438, the anodic oxidation technique by which an insulating layer is formed on the source wire and drain wire of aluminum, to effectively provide the passivation for only the source wire and the drain wire, as disclosed by the prior art document of Japanese Laid-open Patent Publication No. Hei 2(1990)-216129, and the technique designed for the connection between the pixel electrode and the source wire and drain wire are organically combined, for realization of rationalization of the processes and low-temperature film formation.

The present invention provides rationalization of the island-shaped semiconductor layer forming process and the opening-in-the-gate-insulating-layer forming process.

Further, the present invention adopts the rationalized pixel-electrode forming process as disclosed by the prior art document of Japanese Patent Application No. Hei 5(1993)-268726.

According to a 1st aspect of the invention, there is provided an insulated gate transistor comprising a gate wire comprising at least one metal layer having an insulating layer on its surface exclusive of a gate electrode region in which a semiconductor material layer, comprising e.g. a silicone and etc. (equivalent), of a transistor as a switching element is formed; a first semiconductor layer containing no impurities which is formed on the gate electrode through at least one gate insulating layer and forming a channel region (and its insulating portion); a pair (set) of second semiconductor layers containing impurities formed in such a relation that they are partly overlapped with the gate to form a source region and a drain region; a source (electrode-use) wire and a drain wire formed by at least one anodizable metal layer having an anodized layer thereon with the inclusion of the pair of second semiconductor layers; and a silicon oxide layer containing no impurities and a silicon oxide layer containing impurities which are formed on the first semiconductor layer between the source wire and the drain wire.

This constitution enables the opening-in-the-gate-insulating-layer forming process and the passivation insulating layer forming process to reduce.

In accordance with a second aspect of the invention, there is provided an insulated gate transistor according to the first aspect of the invention, wherein an anodizable metal layer is formed as the gate electrode, and an insulating layer on a top surface of the metal layer is the anodized layer.

This constitution enables the insulating layer to be surely secured again on the exposed scan line with a simple process.

In accordance with a third aspect of the invention, there is provided an insulated gate transistor according to the first aspect of the invention, wherein the insulating layer on the gate wire is a layer made of an organic insulating material which is attached by electrodeposition.

This constitution also enables the insulating layer to be surely secured on the scan line.

In accordance with a fourth aspect of the invention, there is provided an insulated gate transistor for a liquid crystal display having an insulating substrate in which unit pixels having pixel electrodes are arranged in two-dimensional matrix (there are, of course, provided a black matrix, a color filter, an opposing electrode and the like, according to need), wherein a scan line comprising at least one metal layer is formed on the insulating substrate in the same process as in the gate electrode of the insulated gate transistor; wherein a lamination of at least one gate insulating layer and a first semiconductor layer containing no impurities, which is larger in width than a gate electrode, is selectively formed on the gate electrode in a transistor forming region; wherein an insulating layer formed on the other gate electrode and the scan line; wherein a pair of second semiconductor layers containing impurities to form a source region and a drain region of the insulated gate transistor, which are formed on the first semiconductor layer on the gate electrode in such a relation as to partly overlap with the gate, are formed; wherein a source wire (signal wire) and a drain wire comprising at least one anodizable metal layer are formed on the pair of second semiconductor layers and the insulating substrate; wherein a transparent conductive pixel electrode is formed on the insulating substrate with the inclusion of the drain wire; an anodized layer is formed on the (surface of, top, side etc.) source wire and the drain wire exclusive of a pixel electrode on the drain wire; and wherein a silicon oxide layer containing no impurities and a silicon oxide layer containing impurities are formed on the first semiconductor layer between the source wire and the drain wire, respectively.

This constitution can allow the number of photo-lithography processes to reduce. This enables the device to be produced with four photomasks {GE (gate-electrode-forming use), AS (amorphous-silicon-patterning-use), SD (source-and-drain use), ITO-use}. Then, there is no need to allow the passivation insulating layer to adhere to the entire area of the glass substrate, unlike the prior art, so that the heat resistance of the insulated gate transistor does not matter any longer. Also, since the opening is not formed in the passivation insulating layer at the stage at which the electrode terminal of the signal wire is formed, there is not produced any problem related to the formation of the contact. In addition, since the insulating layer to protect the channel can be obtained by the amorphous silicon layer containing impurities being modified to silicon oxide layer by anodic oxidation, there is no need to form the channel layer thickly.

In accordance with a fifth aspect of the invention, there are provided an insulated gate transistor for a liquid crystal display, wherein a scan line and a connecting layer, comprising at least one metal layer and serving as the gate electrode of the insulated gate transistor are formed on the insulating substrate, wherein a transparent conductive pixel electrode is formed with the inclusion of a part of the connecting layer; wherein a lamination of at least one gate insulating layer and a first semiconductor layer containing no impurities, which is larger in width than a gate (an integral metal forming the electrode), is selectively formed on a gate electrode in a transistor forming region; wherein an insulating layer is formed on the other gate electrode and the scan line; wherein there are provided a pair of second semiconductor layers containing impurities to form a source region and a drain region of the insulated gate transistor, which are formed on the first semiconductor layer on the gate electrode in such a relation that they are partly overlapped with the gate electrode; wherein a source wire (signal wire) comprising at least one anodizable metal layer and a drain wire are formed on the pair of second semiconductor layers and the insulating substrate with the inclusion of the connecting layer (overlapping in a plane); wherein an anodized layer is formed on the surface of the source wire and the drain wire; and wherein a silicon oxide layer containing no impurities and a silicon oxide layer containing impurities are formed on the first semiconductor layer between the source wire and the drain wire.

This constitution can provide substantially the same effect as in the fourth aspect of the invention. Further, the constitution of the signal wire is simplified to some extent, so that it may be in the form of a two-tier configuration.

In accordance with a sixth aspect of the invention, there is provided an insulated gate transistor for a liquid crystal display, wherein a scan line, comprising at least one metal layer and serving as the gate electrode of the insulated gate transistor as well (integrally formed), and a transparent conductive pixel electrode are formed on the insulating substrate, wherein a lamination of at least one gate insulating layer and a first semiconductor layer containing no impurities, which is larger in width than a gate electrode, is selectively formed on a gate electrode in a transistor forming region; wherein an insulating layer is formed on the other gate electrode and the scan line; wherein a pair of second semiconductor layers containing impurities to form a source region and a drain region of the insulated gate transistor are formed on the first semiconductor layer on the gate electrode in such a relation that they are partly overlapped with the gate in a plane (in fact, the overlapped portions are important as the gate electrode); wherein a source wire (signal wire) comprising at least one anodizable metal layer, and a drain wire with the inclusion of a part of the pixel electrode are formed on the pair of second semiconductor layers; wherein an anodized layer is formed on the surface of the source wire and the drain wire; and wherein a silicon oxide layer containing no impurities and a silicon oxide layer containing impurities are formed (though the both are formed effectively, only the former will do from a practical standpoint) on the first semiconductor layer between the source wire and the drain wire.

This constitution can provide substantially the same effect as in the fifth aspect of the invention.

In accordance with a seventh aspect of the invention, there is provided an insulated gate transistor for a liquid crystal display, wherein a scan line, comprising at least one metal layer and serving as the gate electrode of the insulated gate transistor as well (the film is integrally formed in the successive process and a superfluous part is trimmed), is formed on the insulating substrate, wherein a lamination of at least one gate insulating layer and a first semiconductor layer containing no impurities, which is larger in width than a gate electrode, is selectively formed on a gate electrode in a transistor forming region; wherein an insulating layer is formed on the other gate electrode and the scan line; wherein a pair of second semiconductor layers containing impurities to form a source region and a drain region of the insulated gate transistor are formed on the first semiconductor layer on the gate electrode in such a relation that they are partly overlapped with the gate electrode; wherein a source wire (signal wire) and a drain wire, comprising at least one anodizable metal layer, are formed on the pair of second semiconductor layers; wherein a transparent conductive pixel electrode is formed on the insulating substrate with the inclusion of the drain wire; wherein an anodized layer formed on the surface of the source wire and the drain wire, exclusive of a pixel electrode portion on the drain wire; and wherein a silicon oxide layer containing no impurities and a silicon oxide layer containing impurities are formed on the first semiconductor layer between the source wire and the drain wire.

This constitution can provide substantially the same effect as in the fourth aspect of the invention.

In accordance with an eighth aspect of the invention, there is provided an insulated gate transistor for a liquid crystal display, wherein a scan line, comprising a lamination of a transparent conductive layer and a metal layer and serving as the gate electrode of the insulated gate transistor as well, and a transparent conductive pixel electrode on which the metal layer is partly laminated are formed on the insulating substrate, wherein a first semiconductor layer containing no impurities is formed on the gate electrode through a plasma protective layer and a gate insulating layer to be larger in width than a gate electrode; wherein a pair of second semiconductor layers containing impurities to form a source region and a drain region of the insulated gate transistor are formed on the first semiconductor layer in such a relation as to be partly overlapped with the gate electrode; wherein a source wire (signal wire), comprising at least one anodizable metal layer, and a drain wire, formed with an inclusion of the laminated part with the transparent conductive pixel electrode, are formed on the pair of second semiconductor layers and the gate insulating layer; wherein an anodized layer is formed on the surface of the source wire and the drain wire; and wherein a silicon oxide layer containing no impurities and a silicon oxide layer containing impurities are formed on the first semiconductor layer between the source wire and the drain wire.

This constitution can provide substantially the same effect as in the fifth aspect of the invention.

In accordance with an ninth aspect of the invention, there is provided an insulated gate transistor for a liquid crystal display, wherein a scan line, comprising a lamination of a transparent conductive layer and a metal layer and serving as the gate electrode of the insulated gate transistor as well, and a transparent conductive pixel electrode are formed on the insulating substrate, wherein a first semiconductor layer containing no impurities is formed on the gate electrode through a plasma protective layer and a gate insulating layer to be larger in width than a gate electrode; wherein a pair of second semiconductor layers containing impurities to form a source region and a drain region of the insulated gate transistor are formed on the first semiconductor layer in such a relation as to be partly overlapped with the gate electrode; wherein a source wire (signal wire), comprising at least one anodizable metal layer, and a drain wire, formed with an inclusion of the transparent conductive pixel electrode, are formed on the pair of second semiconductor layers and the gate insulating layer; wherein an anodized layer is formed on the surface of the source wire and the drain wire; and wherein a silicon oxide layer containing no impurities and a silicon oxide layer containing impurities are formed on the first semiconductor layer between the source wire and the drain wire.

This constitution can provide substantially the same effect as in the fifth aspect of the invention.

In accordance with an tenth aspect of the invention, there is provided an insulated gate transistor for a liquid crystal display, wherein a scan line, comprising a lamination of a transparent conductive layer and an anodizable metal layer and serving as the gate electrode of the insulated gate transistor as well, and a transparent conductive pixel electrode on which a metal layer is partly laminated are formed on the insulating substrate, wherein a first semiconductor layer containing no impurities is formed on the gate electrode in a transistor forming region through a plasma protective layer and a gate insulating layer to be larger in width than a gate electrode; wherein an insulating layer formed on the surface of the other scan line and the gate electrode; wherein a pair of second semiconductor layers containing impurities to form a source region and a drain region of the insulated gate transistor are formed on the first semiconductor layer on the gate electrode in such a relation as to be partly overlapped with the gate electrode; wherein a source wire (signal wire), comprising at least one anodizable metal layer, and a drain wire, formed with the inclusion of the laminated part of the transparent conductive pixel electrode on the metal layer, are formed on the pair of second semiconductor layers and the insulating substrate; and wherein a silicon oxide layer containing no impurities and a silicon oxide layer containing impurities are formed on the first semiconductor layer between the source wire and the drain wire.

This constitution can provide a further streamlined process and a reduced number of photo-lithography processes so that the device by use of three photomasks can be produced. In addition, this constitution can provide substantially the same effect as in the fifth aspect of the invention.

In accordance with an 11th aspect of the invention, there is provided an insulated gate transistor for a liquid crystal display, wherein a scan line, comprising a lamination of a transparent conductive layer and a metal layer and serving as the gate electrode of the insulated gate transistor as well, and a transparent conductive pixel electrode are formed on the insulating substrate, wherein a lamination of a plasma protective layer, a gate insulating layer and a first semiconductor layer containing no impurities, which is larger in width than the gate electrode, is formed on the gate electrode in a transistor forming region; wherein an insulating layer is formed on the other scan line and gate electrode; wherein a pair of second semiconductor layers containing impurities to form a source region and a drain region of the insulated gate transistor are formed on the first semiconductor layer on the gate electrode in such a relation as to be partly overlapped with the gate electrode; wherein a source wire (signal wire), comprising at least one anodizable metal layer, and a drain wire, formed with the inclusion of the pixel electrode, are formed on the pair of second semiconductor layers and the insulating substrate; wherein an anodized layer is formed on the surface of the source wire and the drain wire; and wherein a silicon oxide layer containing no impurities and a silicon oxide layer containing impurities are formed on the first semiconductor layer between the source wire and the drain wire.

This constitution can provide substantially the same effect as in the tenth aspect of the invention.

In accordance with an 12th aspect of the invention, there is provided an insulated gate transistor for a liquid crystal display according to any one of the 4th, 5th, 6th, 7th and 10th aspects, wherein the anodizable metal layer is formed as the gate electrode, and the insulating layer is an anodized layer formed on the outside surface of the metal layer.

This constitution can provide the result that the insulating layer can be secured again on the scan layer which was exposed by the island-shapaed semiconductor forming process and the opening-in-the-gate-insulating-layer forming process being simultaneously performed

In accordance with an 13th aspect of the invention, there is provided an insulated gate transistor for a liquid crystal display according to any one of the 4th, 5th, 6th, 7th, 10th and 11th aspects, wherein the insulating layer is an organic insulating layer.

This constitution enables the opening-in-the-gate-insulating-layer forming process to be cut. In addition, this can provide the result of broadening the selections of the material of the scan line, thus releasing the restrictions on the process steps.

The 14th aspect of the invention is viewed from the standpoint of the production method. In accordance with the 14th aspect of the invention, there is provided a production method of an insulated gate transistor for a liquid crystal display comprising: the step that a scan line, which comprises at least one metal layer, and a part of which serves as a gate electrode of the insulated gate transistor as well, is formed on one principal surface of an insulating substrate (on a region where the display portion is formed); the step that three different kinds of material layers in total, comprising at least one gate insulating layer, a first amorphous silicon layer containing no impurities, and a second amorphous silicon layer containing impurities, are allowed to adhere (are formed) in order; the step that the insulating substrate is exposed by selectively leaving the second and first amorphous silicon layers and the gate insulating layer in at least a transistor (a switching element) forming region (and remove all remaining regions); the step that an insulating layer is formed on at least the scan line and the gate electrode which are exposed in an image display portion (inclusive of side surfaces, as well as a top surface); the step that after at least one anodizable metal layer is allowed to adhere, a source wire (signal wire), formed with the inclusion of the second amorphous silicon layer to be partly overlapped with the gate electrode, and a drain wire are formed on the insulating substrate; the step that a transparent conductive pixel electrode is formed on the insulating substrate with the inclusion of the drain wire; and the step that in the condition that a photosensitive resin pattern used for forming a selective pattern (for leaving only a necessary part) of the pixel electrode (material) is used as a mask to protect the pixel electrode, the source wire, the drain wire, all of the second amorphous silicon layer between the source wire and the drain wire, and a part of the first amorphous silicon layer therebetween (this part of layer need not necessarily be anodized theoretically, but should be in practice) are anodized under irradiation of light.

This constitution simply requires four patterns {screens (masks)} for gate electrode (GE) use, amorphous silicon patterning (AS) use, source-and-drain (SD) use, and ITO use. Also, this constitution can provide streamlined island-shaped semiconductor layer forming and opening-in-the-gate-insulating-layer forming processes (the same photomask can be used), so that the device can be produced by using four photomasks. In addition, the constitution can provides the results that the silicon oxide layer containing impurities is formed on the channel between the source wire (source electrode when viewed from the transistor) and the drain wire (drain electrode, likewise), so as to protect the channel; that the anodized layer of an anodizable metal layer is formed on the surface of the source wire (signal wire), to insulate the surface of the same; that the anodized metal layer of an anodizable metal layer is formed on the surface of the drain wire, except the region covered with the transparent conductive layer, to insulate the surface of the same, whereby the pasivation capability is provided.

The 15th aspect of the invention is directed to the 5th aspect of the invention viewed from the standpoint of the production method. In accordance with the 15th aspect of the invention, there is provided a production method of an insulated gate transistor for a liquid crystal display comprising: the step that a scan line, which comprises at least one metal layer and serves as a gate electrode of the insulated gate transistor as well, and a connecting layer are formed on one principal surface of an insulating substrate; the step that at least one gate insulating layer, a first amorphous silicon layer containing no impurities, and a second amorphous silicon layer containing impurities are allowed to adhere in order; the step that the insulating substrate is exposed by selectively leaving the second and first amorphous silicon layers and the gate insulating layer in at least a transistor forming region; the step that an insulating layer is formed on at least the scan line and the gate electrode which are exposed in an image display portion; the wire forming step that after at least one anodizable metal layer is allowed to adhere, a source wire (signal wire), formed with the inclusion of the second amorphous silicon layer to be partly overlapped with the gate electrode, and a drain wire formed with the inclusion of a part of the connecting layer, are formed on the insulating substrate; the step that a transparent conductive pixel electrode is formed on the insulating substrate with the inclusion of a part of the connecting layer; and the step that in the condition that a photosensitive resin pattern used for forming a selective pattern of the pixel electrode is used as a mask to protect the pixel electrode, the source wire, the drain wire, the second amorphous silicon layer between the source wire and the drain wire, and a part of the first amorphous silicon layer therebetween are anodized under irradiation of light.

This constitution simply requires four mask patterns of variant of gate electrode (GE′), AS, SD and ITO. Also, this can provide substantially the same effect as in the production method mentioned above. Further, the constitution of the signal wire is simplified to some extent, so that it may be in the form of a two-tier configuration.

The 16th aspect of the invention is directed to the 6th aspect of the invention viewed from the standpoint of the production method. In accordance with the 16th aspect of the invention, there is provided a production method of an insulated gate transistor for a liquid crystal display comprising: the step that a scan line, which comprises at least one metal layer and serves as a gate electrode of the insulated gate transistor as well, is formed on one principal surface of an insulating substrate; the step that at least one gate insulating layer, a first amorphous silicon layer containing no impurities, and a second amorphous silicon layer containing impurities are allowed to adhere in order; the step that the insulating substrate is exposed by selectively leaving the second and first amorphous silicon layers and the gate insulating layer in at least a transistor forming region; the step that an insulating layer is formed on at least the scan line and the gate electrode which are exposed in an image display portion; the step that a transparent conductive pixel electrode is formed on the insulating substrate; the step that after at least one anodizable metal layer is allowed to adhere, a source wire (signal wire), formed with the inclusion of the second amorphous silicon layer to be partly overlapped with the gate electrode, and a drain wire formed with the inclusion of a part of the pixel electrode, are formed on the insulating substrate; and the step that the source wire, the drain wire, the second amorphous silicon layer between the source wire and the drain wire, and a part of the first amorphous silicon layer therebetween are anodized under irradiation of light.

This constitution simply requires four mask patterns of GE, AS, ITO and SD, thus providing substantially the same effects as in the production method of the liquid crystal image display device mentioned above.

The 17th aspect of the invention is directed to the 7th aspect of the invention viewed from the standpoint of the production method. In accordance with the 17th aspect of the invention, there is provided a production method of an insulated gate transistor for a liquid crystal display comprising: the step that a scan line, which comprises at least one metal layer and serves as a gate electrode of the insulated gate transistor as well, is formed on one principal surface of an insulating substrate; the step that at least one gate insulating layer, a first amorphous silicon layer containing no impurities, and a second amorphous silicon layer containing impurities are allowed to adhere in order; the step that after at least one anodizable metal layer is allowed to adhere, a source wire (signal wire) and a drain wire are formed on the second amorphous silicon layer to be partly overlapped with the gate electrode; the step that the insulating substrate is exposed by selectively leaving the second and first amorphous silicon layers and the gate insulating layer in a region under the source wire and the drain wire and in a transistor forming region; the step that an insulating layer is formed on at least the scan line and gate electrode which are exposed in an image display portion; the step that a transparent conductive pixel electrode is formed, with the inclusion of the drain wire, on the insulating substrate; and the step that in the condition that a photosensitive resin pattern used for forming a selective pattern of the pixel electrode is used as a mask to protect the pixel electrode, the source wire, the drain wire, the second amorphous silicon layer between the source wire and the drain wire, and a part of the first amorphous silicon layer therebetween are anodized under irradiation of light.

This constitution simply requires four mask patterns of GE, SD, AS and ITO, thus providing substantially the same effects as in the production method of the 14th aspect of the invention.

The 18th aspect of the invention is directed to the 8th aspect of the invention viewed from the standpoint of the production method. In accordance with the 18th aspect of the invention, there is provided a production method of an insulated gate transistor for a liquid crystal display comprising: the step that a scan line, which comprises a lamination of a transparent conductive layer and a metal layer and serves as a gate electrode of the insulated gate transistor as well, and a pseudo pixel electrode are formed on one principal surface of an insulating substrate; the step that a plasma protective layer, a gate insulating layer, a first amorphous silicon layer containing no impurities, and a second amorphous silicon layer containing impurities are allowed to adhere in this order; the step that the gate insulating layer is exposed by selectively leaving the second and first amorphous silicon layers in at least a transistor forming region; the step that the pseudo pixel electrode is exposed by removing the gate insulating layer and plasma protective layer on the pseudo pixel electrode; the step that after at least one anodizable metal layer is allowed to adhere, a source wire (signal wire), formed with an inclusion of the second amorphous silicon layer to be partly overlapped with the gate electrode, and a drain wire, formed with the inclusion of a part of the pseudo pixel electrode, are formed on the gate insulating substrate; the step that the metal layer formed on the pseudo pixel electrode is removed; and the step that the source wire, the drain wire, the second amorphous silicon layer between the source wire and the drain wire, and a part of the first amorphous silicon layer therebetween are anodized under irradiation of light.

This constitution simply requires four mask patterns of GE, AS, CW (contact window) and SD. Thus, the process of forming the pixel electrode and the scan line is streamlined, then enabling the device to be produced by using the four photomasks. Hence, there are provided substantially the same effects as in the production method of the 15th aspect of the invention.

The 19th aspect of the invention is directed to the 9th aspect of the invention viewed from the standpoint of the production method. In accordance with the 19th aspect of the invention, there is provided a production method of an insulated gate transistor for a liquid crystal display comprising: the step that a scan line, which comprises a lamination of a transparent conductive layer and a metal layer and serves as a gate electrode of the insulated gate transistor as well, and a pseudo pixel electrode are formed on one principal surface of an insulating substrate; the step that a plasma protective layer, a gate insulating layer, a first amorphous silicon layer containing no impurities, and a second amorphous silicon layer containing impurities are allowed to adhere in order; the step that the gate insulating layer is exposed by selectively leaving the second and first amorphous silicon layers in at least a transistor forming region; the step that the pseudo pixel electrode is exposed by removing the gate insulating layer and plasma protective layer on the pseudo pixel electrode; step that the metal layer formed on the pseudo pixel electrode is removed; the step that after at least one anodizable metal layer is allowed to adhere, a source wire (signal wire), formed with an inclusion of the second amorphous silicon layer to be partly overlapped with the gate electrode, and a drain wire, formed with the inclusion of a part of the pixel electrode, are formed on the gate insulating layer; and the step that the source wire, the drain wire, the second amorphous silicon layer between the source wire and the drain wire, and a part of the first amorphous silicon layer therebetween are anodized under irradiation of light.

This constitution simply requires four mask patterns of GE, AS, CW (contact window) and SD, thus providing substantially the same effects as in the production method of the 18th aspect of the invention.

The 20th aspect of the invention is directed to the 10th aspect of the invention viewed from the standpoint of the production method In accordance with the 20th aspect of the invention, there is provided a production method of an insulated gate transistor for a liquid crystal display comprising: the step that a scan line, which comprises a lamination of a transparent conductive layer and a metal layer and serves as a gate electrode of the insulated gate transistor as well, and a pseudo pixel electrode are formed on an insulating substrate; the step that a plasma protective layer, a gate insulating layer, a first amorphous silicon layer containing no impurities, and a second amorphous silicon layer containing impurities are allowed to adhere in order; the step that the insulating substrate is exposed by selectively leaving the second and first amorphous silicon layers, the gate insulating layer and the plasma protective layer in at least a transistor forming region; the step that an insulating layer is formed on the scan layer and the gate electrode exposed in at least an image display region; the step that after at least one anodizable metal layer is allowed to adhere, a source wire (signal wire), formed with an inclusion of the second amorphous silicon layer to be partly overlapped with the gate electrode, and a drain wire, formed with the inclusion of a part of the pseudo pixel electrode, are formed on the insulating substrate; the step that the metal layer formed on the pseudo pixel electrode is removed; and the step that the source wire, the drain wire, the second amorphous silicon layer between the source wire and the drain wire, and a part of the first amorphous silicon layer therebetween are anodized under irradiation of light.

This constitution can provide streamlined island-shaped semiconductor layer forming and opening-in-the-gate-insulating-layer forming processes and further provide a streamlined process of forming the pixel electrode and the scan line. Thus, the number of photo-lithograph processes can be further reduced As a result of this, the device can be produced by using the three photomasks Accordingly, there are provided substantially the same effects as in the production method of the 15th aspect of the invention

The 21st aspect of the invention is directed to the 11th aspect of the invention viewed from the standpoint of the production method. In accordance with the 21st aspect of the invention, there is provided a production method of an insulated gate transistor for a liquid crystal display comprising: the step that a scan line, which comprises a lamination of a transparent conductive layer and a metal layer and serves as a gate electrode of the insulated gate transistor as well, and a pseudo pixel electrode are formed on one principal surface of an insulating substrate; the step that a plasma protective layer, a gate insulating layer, a first amorphous silicon layer containing no impurities, and a second amorphous silicon layer containing impurities are allowed to adhere in order; the step that the insulating substrate is exposed by selectively leaving the second and first amorphous silicon layers, the gate insulating layer and the plasma protective layer in at least a transistor forming region; the step that the metal layer formed on the pseudo pixel electrode is removed; the step that an insulating layer is formed on the scan line and the gate electrode exposed in at least an image display region; the step that after at least one anodizable metal layer is allowed to adhere, a source wire (signal wire), formed with an inclusion of the second amorphous silicon layer to be partly overlapped with the gate electrode, and a drain wire, formed with the inclusion of a part of the pixel electrode, are formed on the insulating substrate; and the step that the source wire, the drain wire, the second amorphous silicon layer between the source wire and the drain wire, and a part of the first amorphous silicon layer therebetween are anodized under irradiation of light.

This constitution can provide substantially the same effects as in the production method of the 20th aspect of the invention.

In accordance with the 22nd aspect of the invention, there is provided a production method according to any one of 14th, 15th, 16th, 17th and 20th aspects of the invention, wherein the anodizable metal layer is selected as the gate electrode and the insulating layer is formed by the anodized film insulating layer of that metal.

This constitution enables the island-shaped semiconductor layer forming process and the opening-in-the-gate-insulating-layer forming processes to be both performed simultaneously, thus providing a reduced production process. In addition to this, a new insulating layer is formed again on the exposed scan line, thus providing the capability as the liquid crystal image display device.

In accordance with the 22nd aspect of the invention, there is provided a production method according to any one of 14th, 15th, 16th, 17th, 20th and 21st aspects of the invention, wherein the insulating layer is formed by an organic insulating material being allowed to adhere by electrodeposition.

This constitution can provide substantially the same effects as in the 18th aspect of the invention and also can release the restrictions on the material of the scam line.

In accordance with the 24th aspect of the invention, there is provided a production method according to any one of 4th through 11th aspects of the invention, wherein the liquid crystal display is a combined transmissive and refelective liquid crystal display. Accordingly, the transparent conductive pixel electrode according to any one of 4th through 11th aspects of the invention is a semi-transmissive (half miller or half hole) and semi-conductive type one (it is not necessarily formed as a single layer configuration: it may be formed as a two tier configuration). In principle, there are provided a flashing mechanism of a backlight (circuit) and a switching mechanism between a normally white display and a normally black.

This enables the both displays to be used depending circumstances.

In the 25th and 26th aspects of the invention, the liquid crystal display is a reflective liquid crystal display. Accordingly, a miller is sometimes formed under the transparent conductive pixel electrode according to the 4th through 11th aspects of the invention through the insulating layer, or a pixel electrode that doubles as a reflective plate is sometimes formed as a substitution of the transparent conductive pixel electrode.

This enables a reflective liquid crystal display to be produced at a low cost.

The 27th and 28th aspects of the invention can produce substantially the same operation and effect provided for the 24th through 26th aspects of the invention as those of the 12th and 13th aspects of the invention provided for the 4th through 11th aspects of the invention.

### BRIEF DESCRIPTION OF THE DRAWINGS

FIG. 1 is a diagram showing a driving circuit and others packaged in a liquid crystal panel;

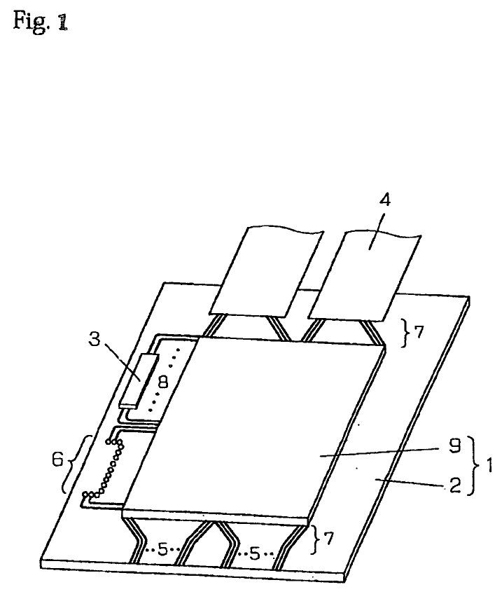

FIG. 2 is a diagram showing an equivalent circuit of the liquid crystal panel;

FIG. 3 is a sectional view of a pixel portion of a conventional liquid crystal panel;

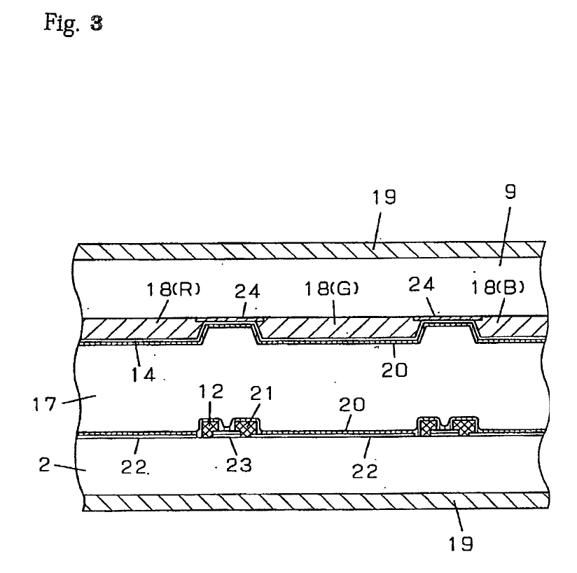

FIG. 4 is a plan view of the pixel portion of the conventional active (matrix) substrate;

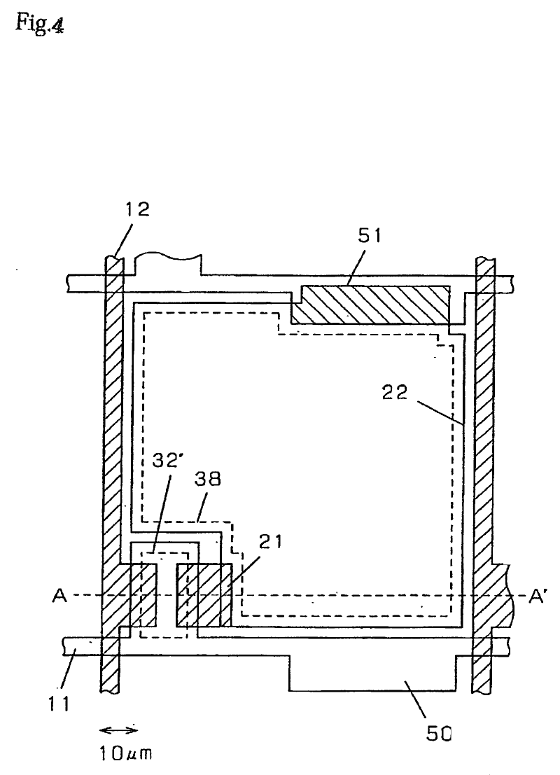

FIG. 5 is a diagram showing the variation in section of the pixel portion of the conventional active substrate with development of the production process;

FIG. 6 is a plan view of the active substrate using a channel etched bottom gate TFT;

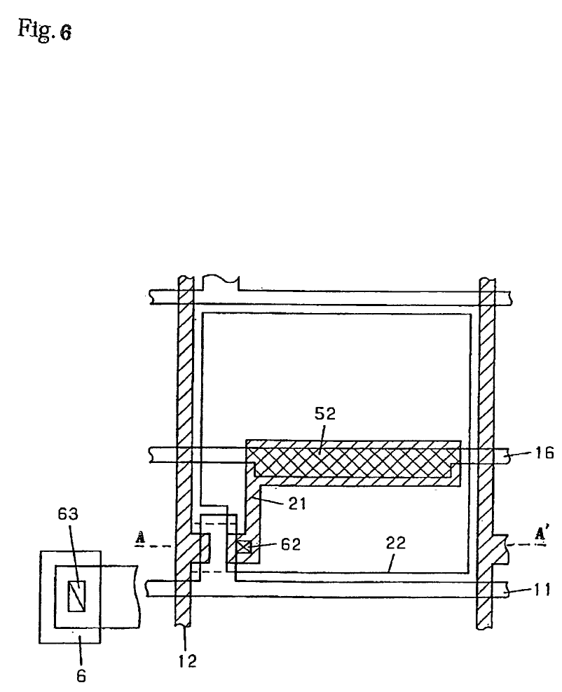

FIG. 7 is a diagram showing the variation in section of the above-noted active substrate with development of the production process;

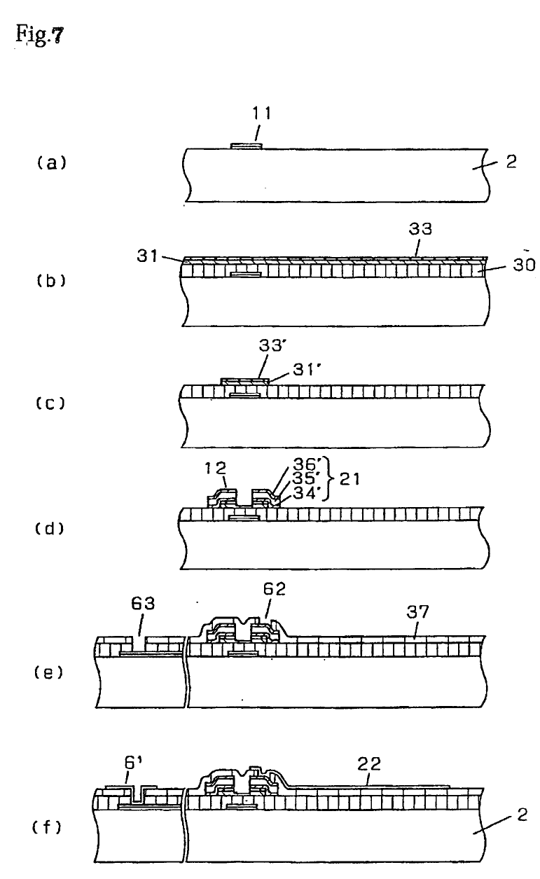

FIG. 8 is a plan view of a pixel portion of a semiconductor device for liquid crystal display of the first embodiment of the present invention;

FIG. 9 is a diagram showing the variation in section of the semiconductor device for liquid crystal display of the first embodiment with development of the production process;

FIG. 10 shows an overview of a substrate selective electrochemical treatment device;

FIG. 11 is a plan view of a semiconductor device for liquid crystal display of the second embodiment of the present invention;

FIG. 12 is a diagram showing the variation in section of the semiconductor device for liquid crystal display of the second embodiment with development of the production process;

FIG. 13 is a plan view of a semiconductor device for liquid crystal display of the third embodiment of the present invention;

FIG. 14 is a diagram showing the variation in section of the semiconductor device for liquid crystal display of the third embodiment with development of the production process;

FIG. 15 is a plan view of a semiconductor device for liquid crystal display of the fourth embodiment of the present invention;

FIG. 16 is a diagram showing the variation in section of the semiconductor device for liquid crystal display of the fourth embodiment with development of the production process;

FIG. 17 is a plan view of a semiconductor device for liquid crystal display of the fifth embodiment of the present invention;

FIG. 18 is a diagram showing the variation in section of the semiconductor device for liquid crystal display of the fifth embodiment with development of the production process;

FIG. 19 is a plan view of a semiconductor device for liquid crystal display of the sixth embodiment of the present invention;

FIG. 20 is a diagram showing the variation in section of the semiconductor device for liquid crystal display of the sixth embodiment with development of the production process;

FIG. 21 is a plan view of a semiconductor device for liquid crystal display of the seventh embodiment of the present invention;

FIG. 22 is a diagram showing the variation in section of the semiconductor device for liquid crystal display of the seventh embodiment with development of the production process;

FIG. 23 is a plan view of a semiconductor device for liquid crystal display of the eighth embodiment of the present invention; and

FIG. 24 is a diagram showing the variation in section of the semiconductor device for liquid crystal display of the eighth embodiment with development of the production process.

(DESCRIPTION OF REFERENCE NUMERALS)

| | |
|---|---|
| 1 | Liquid crystal panel |
| 2 | Active substrate (Insulating substrate, Glass substrate) |
| 3 | Semiconductor integrated circuit chip |
| 4 | TCP film |
| 5, | Electrode terminal |
| 6 | |
| 9 | Color filter (Opposite glass substrate) |
| 10 | Insulated gate transistor |
| 11 | Scan line (Gate electrode) |
| 12 | Signal wire (Source wire, Source electrode) |
| 16 | Storage capacity line |
| 17 | Liquid crystal |
| 19 | Polarizing plate |
| 20 | Alignment layer |
| 21 | Drain wire (Electrode) |
| 22 | (Transparent conductive) Pixel electrode |
| 30 | Gate insulating layer |
| 31 | (First) Amorphous silicon layer containing no impurities |
| 33 | (Second) Amorphous silicon layer containing impurities |
| 34 | (Anodizable) Heat-resistant metal film layer |
| 35 | Low resistance metal layer (AL) |
| 36 | (Anodizable) Intermediate conductive layer |
| 37 | Passivation insulating layer |
| 38 | Opening (formed in passivation insulating layer on pixel |
| | electrode) |
| 55 | Storage electrode |
| 62 | Opening (formed in passivation insulating layer on drain |
| | electrode) |
| 63 | Opening (over the scan line) |
| 65 | Photosensitive resin pattern (for forming the pixel electrode) |
| 66 | Silicon oxide layer containing impurities |
| 67 | Silicon oxide layer containing no impurities |
| 68 | Tantalum pentoxide (Ta₂O₅) |
| 69 | Alumina (Al₂O₃) |
| 70 | Titanium oxide (TiO₂) |
| 71 | Insulating layer (Anodic oxide layer or organic insulating |
| | layer) |
| 72 | Layer of oxides (of interconnection layer) |
| 76 | Plasma protective layer |
| 80 | Interconnection layer |
| 81 | Transparent conductive layer |
| 82 | First metal layer |

### EMBODIMENTS OF THE INVENTION

In the following, the present invention will be described with reference to its preferred embodiments.

(First Embodiment)

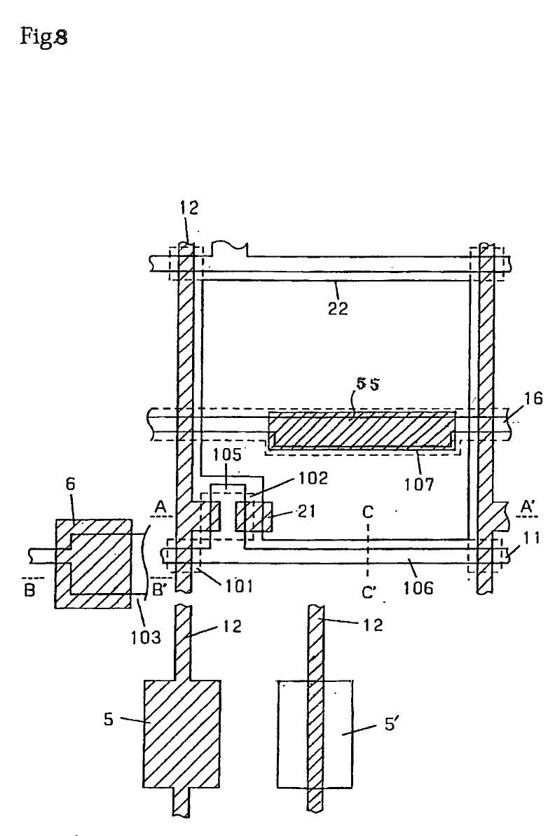

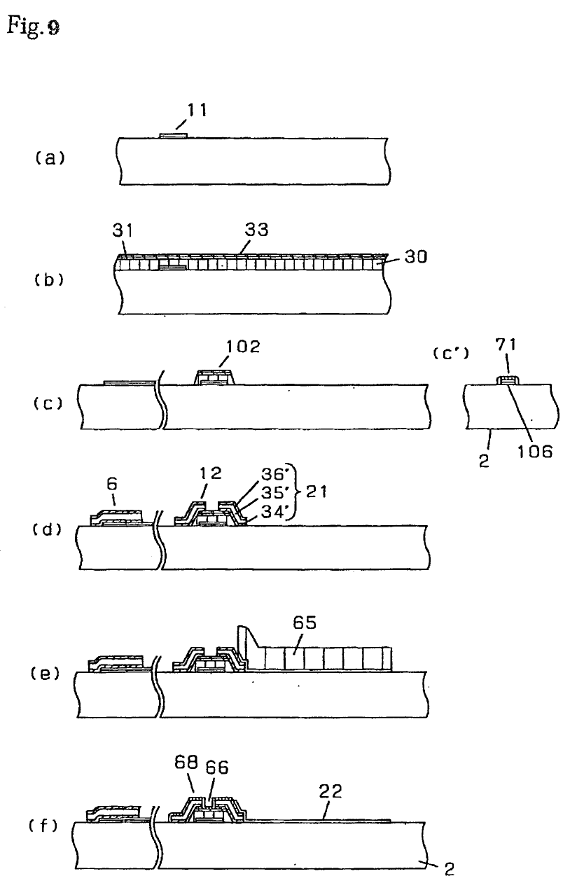

In FIG. 8, there is shown a plan view of a semiconductor device for image display (a TFT aligned active substrate) of the first embodiment. In FIG. 9, there is shown the variation in section of the semiconductor device taken along the line A-A′ line and the line B-B′ of FIG. 8 with development of the production process. The same reference numerals are applied to various corresponding parts to those of the prior art, though the detailed description thereon is omitted.

In a production method of a semiconductor device for image display device (active substrate) according to a 14th aspect of the invention, a first metal layer having thickness of the order of 0.1-0.3 μm is made to adhere to one primary surface of the glass substrate 2 by use of a vacuum film forming device, such as SPT (sputtering system), whereby the gate electrode 11 (and a common capacity line 16) which serves as the scan line as well is selectively formed thereon, first, by use of the microfabrication technology, as shown in FIG. 9(a). Although AL is preferable for the constitution of the scan line, taking its low resistance into consideration, since AL is poor in heat resistance by itself, it is convenient for the constitution of the scan line to adopt a single layer of Cr, Ta, Mo or AL (Zr, Ta) alloys. It should be noted that the AL (Zr, Ta) means AL alloys in which Zr, Ta and the like is added.

Then, as shown in FIG. 9(b), three different kinds of thin film layers comprising the first SiNₓ (silicon nitride) layer 30 to form the gate insulating layer, the first amorphous silicon layer 31 containing almost no impurities to form a channel of the insulated gate transistor, and the second amorphous silicon layer 33 containing impurities to form a source/drain (a source region and a drain region) of the insulated gate transistor are made to adhere to the entire area of the glass substrate 2 in order by use of the PCVD device so that those three layers can have thicknesses of the order of e.g. 0.3 μm, 0.1 μm and 0.05 μm, respectively. (Thus, the first amorphous silicon layer 31 can be allowed to adhere thinner, as compared with the prior art, which is one of the characteristic features of the present invention).

Sequentially, as shown in (c) (Drawing number is sometimes omitted if it can be identified clearly), the second and first amorphous layers 33, 31 and the gate insulating layer 30 are selectively removed, except at least a region 102 of a transistor forming region over and in the neighborhood of the gate electrode and a region over and in the neighborhood of the storage capacity line 16 forming the storage capacity 15, to expose the glass substrate 2. In this process, several kinds of thin films are etched, so that the dry etching using gas (dry etch or dry etching) should be adopted when considered rationally. In a region 101 close to an intersection between the scan line 11 and the signal wire 12, the second and first amorphous silicon layers 33, 31 and the gate insulating layer 30 do not have to be necessarily left, but, in general, it should preferably be left in that the dielectric breakdown between the scan line 11 and the signal wire 12 increases, so that an improved yield ratio is obtained. (The same applies to a region close to an intersection between the storage capacity line 16 and the signal wire 12).

According to the present invention, the island-shaped (isolated) semiconductor layer forming process for forming the semiconductor portion of each individual transistor is practiced by simultaneously etching the semiconductor layer and the gate insulating layer. If the semiconductor layer is not smaller than the gate electrode, light leakage of the insulated gate transistor is caused by the irradiated radiation from the back surface to hinder the function. Also, if the semiconductor layer is on the scan line, it is likely that variation of a parasitic transistor or stay capacitance may be caused. Accordingly, the semiconductor layer is formed to be smaller than the gate electrode, and the semiconductor layer on the scan line is removed. As a result of this, a part 105 of the gate electrode and a large part 106 of the scan line are exposed (except a storage capacity forming region where the storage capacity is constituted between the gate electrode and the previous scan line, as mentioned later). However, in the state of liquid crystal panel, a DC bias is always applied between the scan line 11 and the opposing electrode 14, so that when the scan line 11 is kept in the exposed state, the liquid crystal panel cannot be used as the liquid crystal device.

It is necessary, therefore, that an insulating layer 71 is formed on at least a part of the scan line 106 and gate electrode 105 exposed in the image display portion (liquid crystal panel) by proper means. It is enough for such an insulating layer 71 to have a film thickness of 0.1-0.5 μm Preferably, the insulating layer 71 is formed to extend to the neighborhood of the region where the electrode terminal 6 of the scan line is formed.

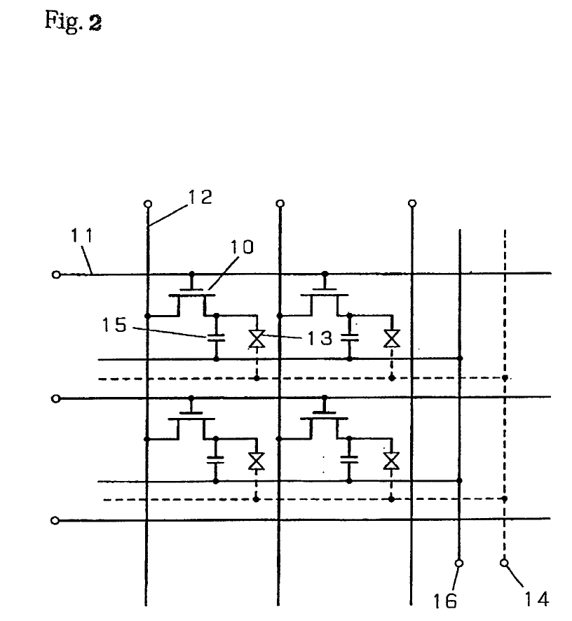

Reference is given here to a insulating layer 71 forming process wherein anodizable material is used for the scan line 11 so that the insulating layer can be formed on the exposed scan line 11 via the anodic oxidation (according to the 12th aspect of the invention and the 22nd aspect of the invention). The materials that may be used singularly for the anodizable metal layer include, for example, Ta and AL. Alternatively, silisides which are alloys of a high melting metal, such as Ta, W, Mo or Cr, and Si may be used. Although AL is overwhelmingly preferable, taking its low resistance into consideration, since AL is poor in heat resistance by itself, it is preferable for the constitution of the scan line to select a single layer constitution of e.g. AL (Zr, Ta) alloys, as mentioned above, or a laminated constitution of e.g. AL/Ta, Ta/AL/Ta and AL/AL(Zr, Ta), for producing low resistance for the scan line. For example, when the exposed scan line 11 is anodized by using AL/AL(Ta) for material of the scan line, an alumina (AL₂O₃) layer 71 of an insulating layer can selectively be formed on the surface of the exposed scan line 11, as shown in FIG. 2(c′).

In this anodic oxidation process, the second amorphous silicon layer 33′ is not oxidized. On the contrary, even when a pin hole, extending through the gate insulating layer 30′ over the gate electrode 11, the first amorphous silicon layer 31′ and the second amorphous silicon layer 33′, is generated, it is filled up by the anodic oxidation. This can provide the result of reducing the inter-layer short-circuit between the gate electrode (scan line) 11 and the signal wire 12, thus providing the side benefit of providing an improved yield.

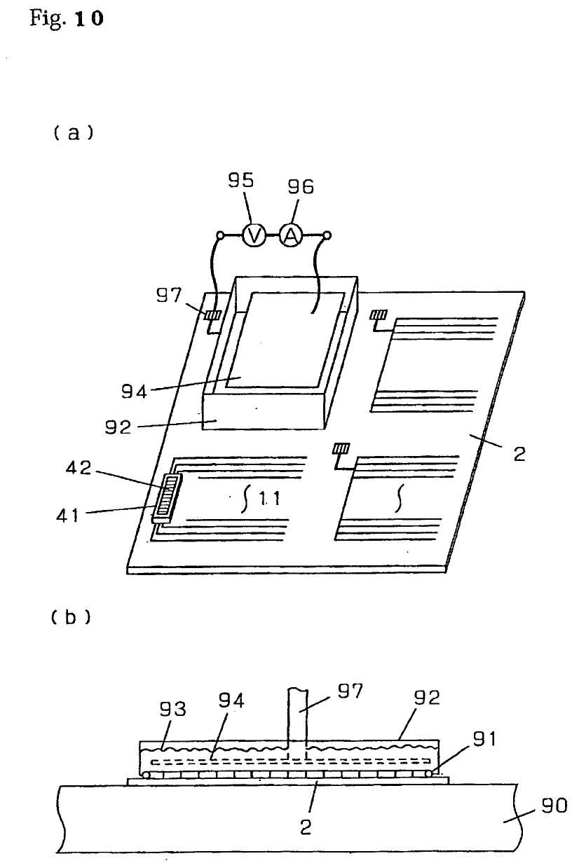

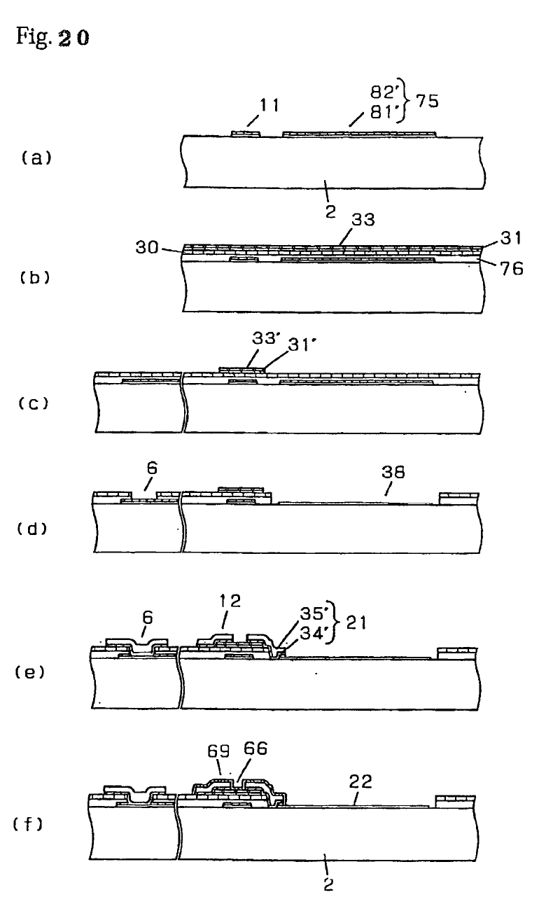

However, when the exposed scan line 106 and the gate electrode 105 are subjected to the anodic oxidation, the selective anodic oxidation process using the photosensitive resin pattern as the mask increases the number of production processes. In view of this, it is preferable to adopt a substrate selective chemical treating device in respect of which the inventors previously filed the application for patent (Inspection and Repair of Active Substrate, PCT/JP/00/07250). This chemical treating device comprises, as shown for example in FIG. 10, the glass substrate 2 held on a level stage 90 and an insulative casing-like container 92 having a resin O-ring 91 embedded at one end thereof and pressed in the glass substrate 2. In the casing-like container 92, chemically synthesized solution 93 is injected and a DC voltage is applied between an electrode plate 94 and the glass substrate 2 which are fixed to a vertically movable supporting rod 97 through an ammeter 96 by a DC power source 95, to perform the anodic oxidation. In FIG. 20, in order to anodize the scan lines 11 adhering to the device, there is provided a terminal 97 to which the scan lines 11 collectively arranged in parallel are connected. A negative (−) electric potential and a positive (+) electric potential are applied to the electrode plate 94 and the terminal 97, respectively, from the DC power source 95. Thus, the glass substrate 2 can selectively be anodized by the size of the casing-like container 92 and O-ring 91 used being properly selected and by the terminal 97 into which a plurality of electrode lines (scan lines or signal wires) to be anodized are collected or the electrode lines being arranged at the outside of the periphery of the casing-like container 92.

Further, reference is given to another insulating layer 71 forming process wherein an organic insulating layer is formed on the scan line 11 by electrodeposition (according to the 13th aspect of the invention and the 23rd aspect of the invention). As disclosed by a literature of IEEE vol.12, C-112 (by Institute of Electrical Engineers (IEE), 1992), polyamic acid salt is selected from the materials that can be used to form by electrodeposition an thin organic insulating film that can ensure the required insulating property for the device, and a solution containing about 0.01% polyamic acid salt is prepared as the electrodeposing solution. Then, the solution is electrodeposited by the application of the positive (+) potential to the scan line 11, to form a polyimide layer 71 selectively on the surface of the exposed scan line 11, as shown in FIG. 2(c′). The polymide layer 51 can be allowed to have thickness of 0.5 μm or more with ease at a few electrodeposition voltage.

Preferably, the polyimide layer 71, after formed, is heat-treated at 200-300° C. for a few minutes to a few tens minutes, to improve its insulating property and chemical resistance (for example, the photosensitive resin pattern is removed in a subsequent process, so that the thin organic insulating film is then required to have the chemical resistance against e.g. resist peeling solution). The required insulating property is governed by the heat resistance of the insulated gate transistor and the composition of the liquid crystal material, so that an optimum value in the heating condition may be determined experimentally. It is noted, however, that since the selective anodic oxidation process in which the photosensitive resin pattern is used as the mask when the organic insulating layer 71 is formed on the exposed scan line 106 and gate electrode 105 involves the increased number of production processes, the substrate selective chemical treatment device is a recommendation.

It is the matter to keep in mind when the insulating layer is formed on the exposed scan line by electrodeposition or by anodic oxidation that although it is necessary that the scan lines are all electrically arranged in parallel or in series for the anodic oxidation, that arrangement in parallel/series must be released in a sequent production process, for avoidance of any hindrance against actual operation as the liquid crystal device as well as for an electric inspection of the active substrate 2. The release may be performed, for example, by cutting or breaking the glass substrate 2 or by evaporating the wire passage formed in parallel/series by irradiation of a high energy line such as a laser beam.

After the insulating layer 71 is formed on the exposed scan line 106 and gate electrode 105, the heat-resistant, thin metal film layer 34 made of e.g. Ta, Ti, an thin AL film layer 35 having thickness of the order of 0.3 μm, and the heat-resistant, thin metal film layer 36 made of e.g. Ta are made to adher in order in the form of an anodizable heat-resistant thin metal layer having thickness of the order of 0.1 μm, a low resistance wiring layer, and an anodizable intermediate conductive layer having thickness of the order of 0.1 μm, respectively, by use of the vacuum film forming device such as SPT, as shown in FIG. 9(d). Then, these three metal layers are etched with the photosensitive resin pattern by use of the microfabrication technology, to selectively form the drain wire 21 of the insulated gate transistor and the signal wire 12 serving as the source wire as well. Depending on the required resistant values for the source/drain wires 12, 21, it is possible to adopt a single layer of e.g. a thin Ta film having thickness of the order of 0.3 μm, instead of a complex three layer. This is an advantageous alternative in cost.

When the source/drain wires 12, 21 are formed into a selective pattern, there is no need to etch the second amorphous silicon layer 33′ containing the impurities and the first amorphous silicon layer 31′ containing no impurities, differently from the prior art. At the same time that the source/drain wires 12, 21 are formed, the electrode terminals 6 of the scan lines are formed with the inclusion of the exposed scan lines 11 in the regions other than the image display portion are formed. Instead of forming the electrode terminal 6 of the scan line in this process, the transparent conductive electrode terminal 6′ may be formed in the sequent pixel electrode 22 forming process. To minimize the exposure of the scan line 11, the electrode terminal 6 should preferably be formed with the inclusion of the insulating layer 71 formed on the scan line 11.

Further, as shown in (e), for example ITO (Indium-Tin-Oxide) is made to adhere to the entire area of the glass substrate 2 in the form of the transparent conductive layer having thickness of the order of 0.1-0.2 μm by use of the vacuum film forming device, such as SPT. Then, the pixel electrode 22 is selectively formed with the inclusion of a part of the drain wire 21 on the glass substrate 2 by use of the microfabrication technology. With the photosensitive resin pattern 65 used for forming the selective pattern of the pixel electrode 22 as the mask, the source/drain wires 12, 21 are anodized under irradiation of light, to form the layer of oxides, and also the second amorphous silicon layer 33′ containing the impurities and first amorphous silicon layer 31′ containing no impurities as well exposed between the source/drain wires 12, 21 are partly anodized to form the second silicon dioxide layer (SiO₂) 66, 67 of the insulating layer.

The Ta and the laminated Ta, AL and Ti are exposed at the top of the source/drain wires 12, 21 and at the side thereof, respectively. The anodic oxidation permits the Ta, the AL and the Ti to be modified to tantalum pentoxide (Ta₂O₅) 68 of the insulating layer, alumina (AL₂O₃) 69 of the insulating layer and titanium oxide (TiO₂) 70 of the high-resistant semiconductor, respectively. Although the titanium oxide (TiO₂) 70 is not the insulating layer in a narrow sense, since it is very small in thickness, it presents no substantial problem on the passivation. Also, though it is desirable that Ta is selectively used for the heat-resistant thin metal film layer 34, attention must be paid that the Ta lacks the function to absorb the layer of oxides on the surface of the base to facilitate the ohmic contact, different from Ti.

If the second amorphous silicon layer 33′ containing the impurities is incompletely protected from the insulating layer, increase of current leakage of the insulated gate transistor is caused. Consequently, it is a critical point of the anodic oxidation process that the anodic oxidation is performed under irradiation of light. The reason therefore is as follows. The second amorphous silicon layer 33′ containing the impurities is modified to the silicon oxide layer 66 from its surface contacting with the chemically synthesized solution. As anodic oxidation progresses, thickness of the second amorphous silicon layer 33′ containing the impurities decreases, so that the electric current cannot pass through the second amorphous silicon layer 33′ containing impurities so fully as to anodize the drain wire 21.

When the Anodic oxidation is performed under irradiation of light, the first amorphous silicon layer 31′ containing no impurities contacting with the second amorphous silicon layer 33′ containing the impurities can be allowed to change from a high resistance state in which little electric current passes to a low resistance state in which a required amount of electric current is allowed to pass by the photoelectric effect. Specifically, when the current leakage of the insulated gate transistor exceeds μA by irradiation of fully intense light of the order of 10,000 lux, a current density of the order of 10 mA/cm² (milliampere/square centimeter) required for obtaining good quality of film is estimated by the calculation from an area of the channel portion between the source/drain wires 12, 21 and the drain wire 21.

When even a part (the order of 100 Å) of the first amorphous silicon layer 31′ containing no impurities contacting with the silicon oxide layer (SiO₂) 66 containing the impurities formed by setting a formation voltage to be higher by the order of 10 V than the formation voltage in excess of 100 V enough to anodize the second amorphous silicon layer 33′ containing the impurities to modify it to the silicon oxide layer (SiO₂) 66 of the insulating layer is modified to the silicon oxide layer (SiO₂) 67 containing no impurities, the electrical isolation between the source/drain wires 12, 21 can be brought to perfection.

It is enough for the respective layers of oxides of tantalum pentoxide (Ta₂O₅) 68, alumina (AL₂O₃) 69 and titanium oxide (TiO₂) 70 to have thickness of the order of 0.1-0.2 μm for the passivation of the wirings. This can be achieved by using chemically synthesized solution, such as ethylene glycol and application of voltage in excess of 100 V. It is the matter to keep in mind when the source/drain wirings 12, 21 are anodized that, needless to say, it is necessary that the signal wires 12 are all electrically arranged in parallel or in series for the anodic oxidation, but that arrangement in parallel/series must be released in a sequent production process, for avoidance of any hindrance against actual operation as the liquid crystal device as well as for an electric inspection of the active substrate 2. Or, some mechanism to collect the electrode terminal, such as the mechanism to press the metal electrode 42 to a plurality of electrode terminals through an anisotropic conductive rubber 41 as in the substrate selective electrochemical device, is necessary, as shown in FIG. 10.

The pixel electrode 22 is covered with the photosensitive resin pattern 65. This is not only because there is no need to anodize the pixel electrode 22, but also because there is no need to secure the formation voltage passing through the drain electrode 21 by way of the insulated gate transistor more than necessary. It is noted further that when the anodic oxidation is performed, the electrode terminal 6 of the scan line 11 is in electrical floating (neutral), so that no anodized layer is formed thereon. When the glass substrate 2 selective anodic oxidation is practiced, a part of the signal wire 12 can be in the form of the electrode terminal 5 at any regions other than the image display portion, as shown in 8. In the conventional anodic oxidation method in which the entire glass substrate 2 is immersed into the chemically synthesized solution, unless a suitable mask material is used in combination, the source/drain wires 12, 21 cannot be anodized selectively. As a result of this, the electrode terminal 5′ comprising the transparent conductive layer is formed with the inclusion of a part of the signal wire 12 in the regions other than the image display portion, as separately illustrated. This constitution is the same as the connection between the pixel electrode 22 and the drain wire 21 as shown in FIG. 9(f). Finally, the photosensitive resin pattern 65 is removed to complete the active substrate 2, as shown in (f). The active substrate 2 thus produced and the color filter are laminated and further are subjected to necessary processes to complete the liquid crystal panel.

Regarding the constitution of the storage capacity 15, there is shown an example thereof in FIG. 8 in which the storage capacity line 16 and the pixel electrode 22 are arranged via the gate insulating layer 30, the amorphous silicon layer 31 containing no impurities and the amorphous silicon layer 33 containing the impurities. The gate insulating layer 30, the amorphous silicon layer 31 containing no impurities, and the amorphous silicon layer 33 containing the impurities (the nearer to the signal wire 12, the more it is oxidized and modified to the silicon oxide layer 66) are selectively formed 107 on and in the neighborhood of the storage capacity line 16 in a required place only. It is noted, for confirmation, that when the storage electrode 55 is formed on the storage capacity line 16 by use of the source/drain wire material at the formation of the source/drain wires 12, 21, the property of the storage capacity 15 is stabilized. The constitution of the storage capacity 15 is not limited to the illustrated one The storage capacity may be constituted by the insulating layer including the gate insulating layer 30 being interposed between the pixel electrode 22 and the previous scan line 11. Other possible alternatives may be taken, though the detailed description thereon is omitted here.

(Second Embodiment)

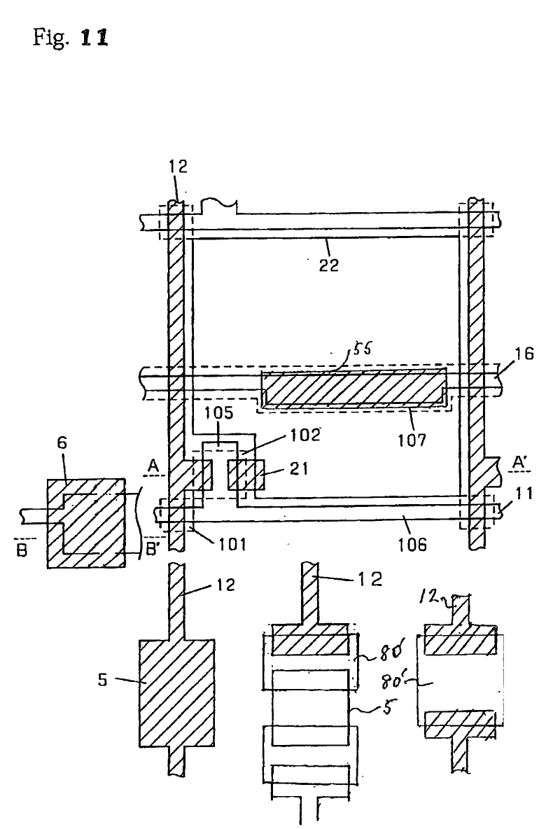

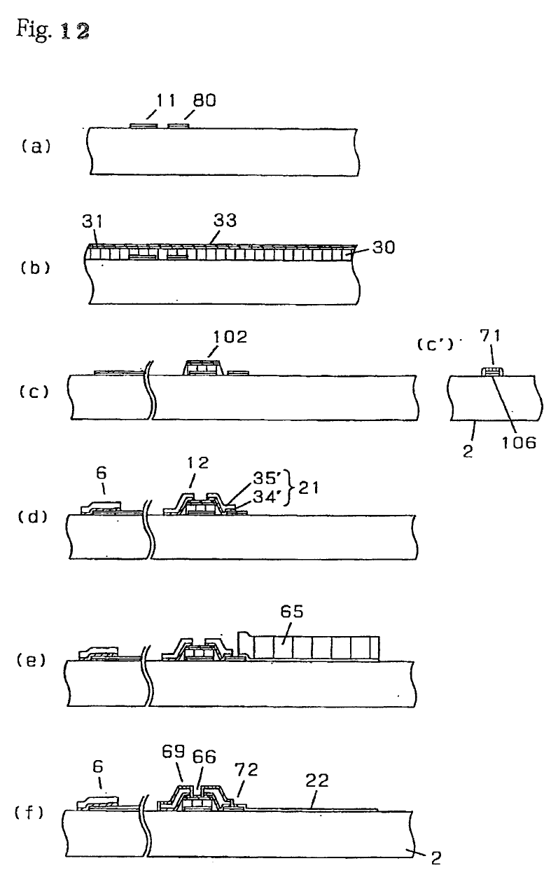

In this embodiment, an additional connecting layer is introduced for the connection between the pixel electrode and the drain wire, to form the source/drain wires in a two-tier structure, which is the characteristic feature of this embodiment. In FIG. 11, there is shown a plan view of a pixel portion of the liquid crystal device of this embodiment. In FIG. 12, there is shown the variation in section of a principal part of the liquid crystal device with development of the production process.

In a production method of an active substrate of this embodiment (according to a 15th aspect of the invention), Ta, AL/Ta and equivalent are made to adhere to one primary surface of the glass substrate 2 in the form of an anodizable metal layer having thickness of the order of 0.1-0.3 μm by use of the vacuum film forming device, such as SPT (sputtering system), whereby the gate electrode 11, which serves as the scan line as well, and a connecting layer 80 are selectively formed thereon by use of the microfabrication technology, first, as shown in FIG. 12(a)

Then, as shown in FIG. 12(b), three different kinds of thin film layers comprising the first SiNₓ (silicon nitride) layer 30 to form the gate insulating layer, the first amorphous silicon layer containing almost no impurities to form the channel of the insulated gate transistor, and the second amorphous silicon layer 32 containing impurities to form the source/drain of the insulated gate transistor are made to adhere to the entire area of the glass substrate 2 in order by use of the PCVD device so that those three layers can have thicknesses of the order of e.g. 0.3 μm, 0.1 μm and 0.05 μm, respectively.

Sequentially, as shown in (c), the second and first amorphous layers 33, 31 and the gate insulating layer 30 are selectively removed, except at least the transistor forming region 102 (and a region 107 over and in the neighborhood of the storage capacity line 16), to expose the glass substrate 2. In this process, several kinds of thin films are etched, so that the dry etching using gas (dry etch) should be adopted, as already mentioned.

Then, the anodized layer 71 is formed on the exposed scan line 11 and gate electrode 105 by anodic oxidation, or the organic insulating layer 71 is formed thereon by electrodeposition. In this process, the connecting layer 80 is isolated and is in electrical floating, so that the insulating layer 71 is not formed on the connecting layer 80.

Thereafter, as shown in (d), the heat-resistant, thin metal film layer 34 made of e.g. Ti, Ta, and the thin AL film layer 35 having thickness of the order of 0.3 μm are made to adher in order in the form of the heat-resistant metal layer having thickness of the order of 0.1 μm and the low resistance wiring layer, respectively, by use of the vacuum film forming device such as SPT. Then, these two metal layers are etched in order with the photosensitive resin pattern by use of the microfabrication technology, to selectively form the signal wire 12, serving as the source wire of the insulated gate transistor as well, and the drain wire 21 with the inclusion of a part of the connecting layer 80. At the same time that the source/drain wires 12, 21 are formed, the electrode terminals 6 of the scan lines are formed with the inclusion of the exposed scan lines 11 in the regions other than the image display portion are formed Alternatively, instead of forming the electrode terminal 6 of the scan line in this process, the transparent conductive electrode terminal 6′ may be formed in the sequent pixel electrode 22 forming process. Further, a part of the exposed scan line may be formed as the electrode terminal 6, without forming the transparent conductive electrode terminal 6′.

Sequentially, as shown in FIG. 12(e), for example ITO (Indium-Tin-Oxide) is made to adhere onto the glass substrate 2 in the form of the transparent conductive layer having thickness of the order of 0.1-0.2 μm by use of the vacuum film forming device, such as SPT. Then, the pixel electrode 22 is selectively formed with the inclusion of a part of the connecting layer 80 on the glass substrate 2 by use of the microfabrication technology

Sequentially, with the photosensitive resin pattern 65 used for forming the selective pattern of the pixel electrode 22 as the mask, the source/drain wires 12, 21 are anodized under irradiation of light, to form the layer of oxides, and also the second amorphous silicon layer 33′ containing the impurities and first amorphous silicon layer 31′ containing no impurities as well exposed between the source/drain wires 12, 21 are partly anodized to form the silicon oxide layer (SiO₂) 66, 67 of the insulating layer. The AL and the laminated AL and Ti (or Ta) are exposed at the top of the source/drain wires 12, 21 and at the side thereof, respectively. The anodic oxidation permits the AL and the Ti to be modified to alumina (AL₂O₃) 69 of the insulating layer and titanium oxide (TiO₂) 70 of the semiconductor, respectively (Ta is modified to tantalum oxide (Ta₂O₅) of the insulating layer). The anodized layer 72 is also formed on the surface of the connecting layer 80 that is not covered with the drain wire 21 and the pixel electrode 22, so that it is necessary that the connecting layer 80 is formed by an anodizable metal layer or siliside layer.

The glass substrate 2 selective anodic oxidation, when practiced, enables a part of the signal wire 12 to be in the form of the electrode terminal 5 in the regions other than the image display portion, as shown in FIG. 11. The connecting layer 80′ may alternatively be in the form of the electrode terminal without any intercalation of the transparent conductive layer. Otherwise, the electrode terminal 5′ comprising the transparent conductive layer will be formed with the inclusion of a part of the connecting layer 80′ in the regions other than the image display portion, as separately illustrated. This constitution is identical to the connection form between the pixel electrode 22 and the drain wire 21 shown in FIG. 12(f). Finally, the photosensitive resin pattern 65 is removed to complete the active substrate 2, as shown in FIG. 12(f). The active substrate 2 thus produced and the color filter are laminated to produce the liquid crystal panel.

(Third embodiment)

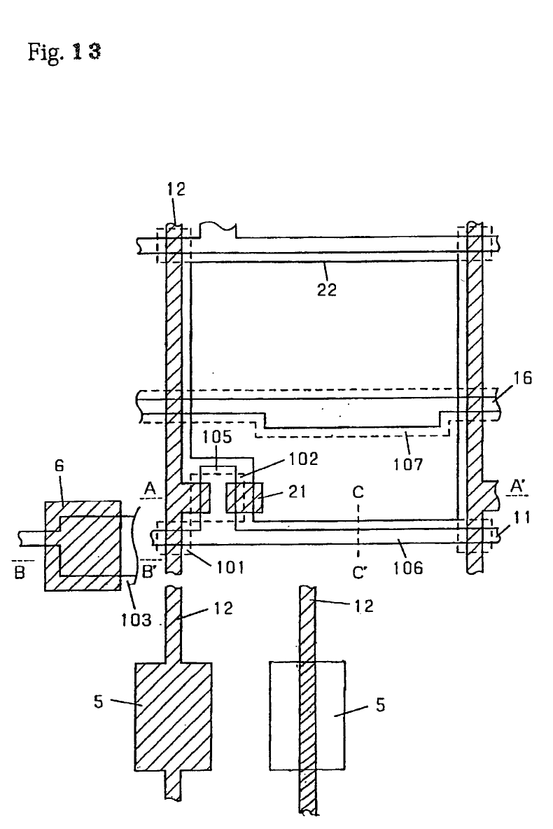

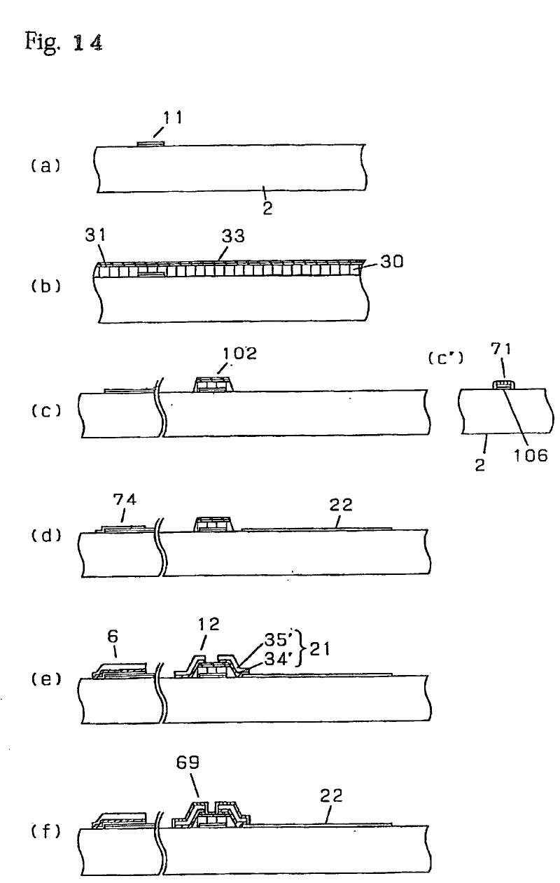

In this embodiment, the island-shaped semiconductor layer forming process, the source/drain wire forming process and the pixel electrode forming process are reversed in order, to thereby produce a variant of the insulated gate transistor. A plan view of the pixel of the semiconductor device of this embodiment is shown in FIG. 13, and a variation in section of a principal part thereof is shown in FIG. 14.

In this embodiment (i.e., in the active substrate production method according to the 16th aspect of the invention), the processes leading up to the island-shaped semiconductor layer and gate insulating layer forming process shown in FIG. 14(c) and the subsequent process of forming the insulating layer 71 on the exposed scan line 11 and gate electrode 105 are the same as those of the first embodiment. However, there is the alternative that the organic insulating layer 71 is formed by the electrodeposition, so it is possible to use Cr, Mo and equivalent in the form of a non-anodizable metal layer for the scan line 11, as already mentioned. Thereafter, as shown in FIG. 14(d), ITO (Indium-Tin-Oxide) is made to adhere onto the glass substrate 2 in the form of the transparent conductive layer having thickness of the order of 0.1-0.2 μm by use of the vacuum film forming device, such as SPT. Then, the pixel electrode 22 is selectively formed on the glass substrate 2 by use of the microfabrication technology. When the scan line 11 exposed in the regions other than the image display portion is also covered with the transparent conductive layer 74 in this process, any side effects caused by the battery effect can be avoided with ease in the subsequent process. Alternatively, it is feasible that no transparent conductive layer is left in this process, but instead the electrode terminal 6 identical in material to the source/drain wires is formed in the subsequent source/drain wire forming process. Further, it is also feasible that a part of the exposed scan line 11 is formed as the electrode terminal 6 without any source/drain wire material being left.

Sequentially, as shown in FIG. 14(e), the heat-resistant, thin metal film layer 34 made of e.g. Ti, Ta and the thin AL film layer 35 having thickness of the order of 0.3 μm are made to adher in order in the form of the heat-resistant metal layer having thickness of the order of 0.1 μm and the low resistance wiring layer, respectively, by use of the vacuum film forming device such as SPT. Then, these two metal layers are etched (superfluous parts are removed in order with the photosensitive resin pattern by use of the microfabrication technology, to selectively form the signal wire 12, serving as the source wire of the insulated gate transistor as well, and the drain wire 21 with the inclusion of a part of the pixel electrode 22.

Sequentially, as shown in (f), the source/drain wires 12, 21 are anodized under irradiation of light, to form the layer of oxides 69, 70 (or 68) thereon, and also the second amorphous silicon layer 33′ containing the impurities and first amorphous silicon layer 31′ containing no impurities as were exposed between the source/drain wires 12, 21 are partly anodized to form the silicon oxide layer (SiO₂) 66, 67 of the insulating layer.

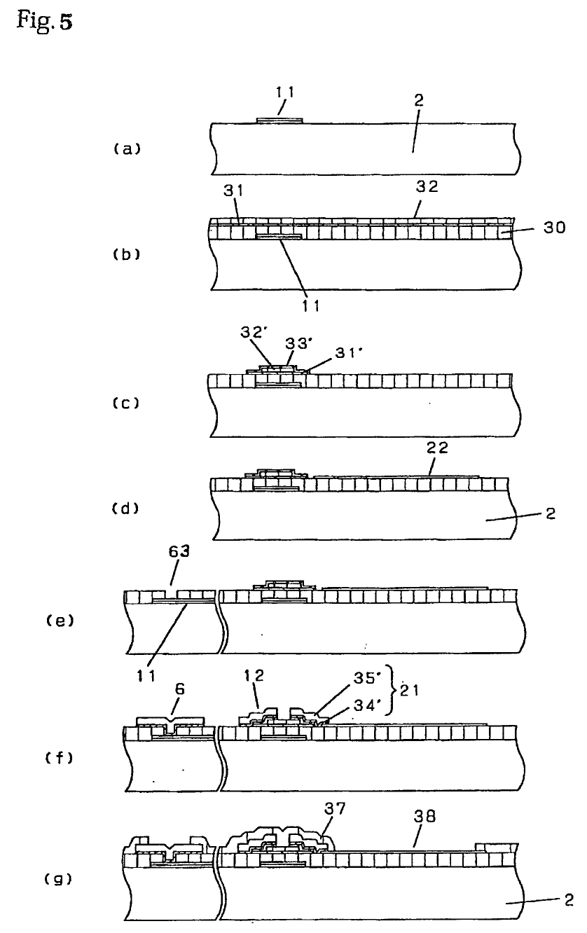

The glass substrate 2 selective anodic oxidation, when practiced, enables a part of the signal wire 12 to be in the form of the electrode terminal 5 in the regions other than the image display portion, as shown in FIG. 5. Otherwise, the signal wire 12 will be formed with the inclusion of a part of the electrode terminal 5′ comprising the transparent conductive layer in the regions other than the image display portion, as separately illustrated. This constitution is identical to the connection form between the pixel electrode 22 and the drain wire 21 shown in FIG. 14(f). The active substrate 2 thus produced and the color filter are laminated to produce the liquid crystal panel.

Thus, in this embodiment, the source/drain wires 12, 21 can be formed in the two-tier structure comprising the heat-resistant thin metal layer and the aluminum alloy layer. This embodiment is totally different from the first and second embodiments in that when the source/drain wires 12, 21 and the second amorphous silicon layer 33′ are anodized, the pixel electrode 22 which is electrically connected to the drain wire 21 is also exposed and thus is simultaneously anodized. Due to this, depending on the quality of film of the transparent conductive layer 22, the resistance value may be increased by the anodic oxidation. In that event, the film forming conditions of the transparent conductive layer 22 must be changed properly so that the transparent conductive layer can have a film quality of short of oxygen, whilst however the transparency of the transparent conductive layer 22 is not reduced by the anodic oxidation. The electric current required for anodizing the drain wire 21 and the pixel electrode 22 is also supplied thereto passing through the channel of the insulated gate transistor. Since the pixel electrode 22 has a large area, a large formation current is needed. No matter how strong outside light the substrate is irradiated with, since anodic current is hindered by the resistance of the channel portion, it is hard to form on the drain wire 21 the alumina layer 69 corresponding in quality and thickness to that formed on the source wire 12 by simply extending the chemically synthesizing time. However, even when the alumina layer 69 formed on the drain wire 21 is somewhat incomplete, it is often the case that the reliability having no practical problem is obtained. This is because the driving signals applied to the liquid crystal cell are basically output with alternate current and there is little direct current components between the opposing electrode 14 and the source/drain wires 12, 21. The method in which an offset voltage is applied to the opposing electrode 14 so that flicker (direct current components) can be minimized is the fundamental method of driving the active liquid crystal panel. The value of the third embodiment is appreciated from the fact that the passivation need not necessarily be formed on the drain wire 21 (pixel electrode 22).

When the second amorphous silicon layer 33′ containing the impurities is anodized to modify it to the silicon oxide (SiO₂) layer 66 of the insulating layer, it is desirable that the silicon oxide (SiO₂) layer 66 formed is even in thickness in the channel direction. From the viewpoint of the isolation of the source/drain, even when the silicon oxide (SiO₂) layer 66 having uneven thickness in the channel direction, since the nearer to the signal line 12 is a region, the more readily the anodic oxidation can be allowed to reach the first amorphous silicon layer 31′, the insulated gate transistor can be evaluated by measuring the leakage current of the insulating gate transistor. The same applied to the passivation ability of the channel portion. The passivation ability for the insulated gate transistor alone or for the liquid crystal image display device can be evaluated from the reliability test results.

(Fourth Embodiment)

This embodiment relates to the island-shaped semiconductor layer forming process, the source/drain wire forming process and the pixel electrode forming process, as is the case with the third embodiment.

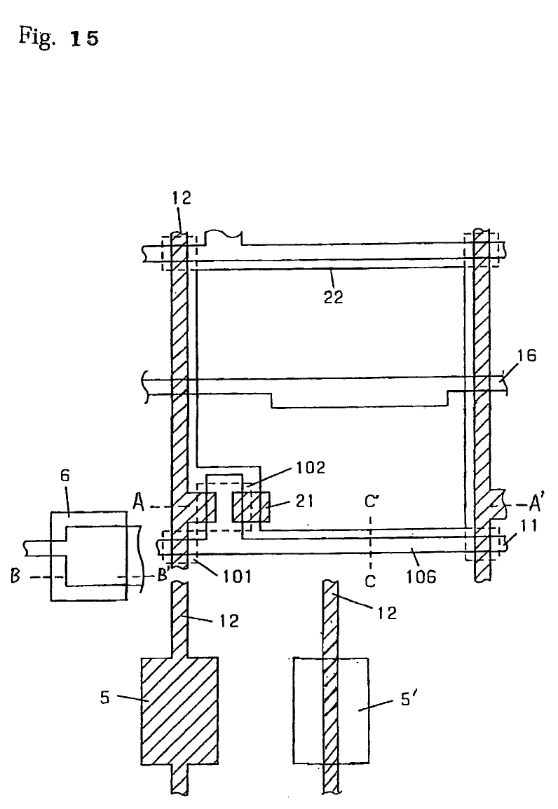

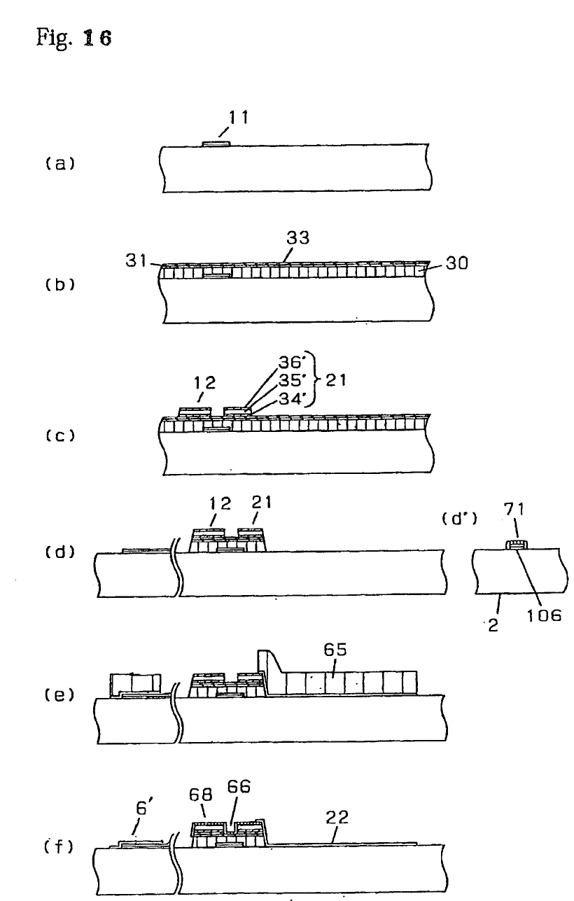

This embodiment (the production method of the active substrate according to the 17th aspect of the invention) is shown in FIGS. 15 and 16.

The processes up to the process of forming the second semiconductor film layer containing the impurities shown in FIG. 16(b) progress in the same production process as in the first embodiment. Thereafter, as shown in FIG. 16(c), the heat-resistant, thin metal film layer 34 made of e.g. Ti, Ta, the thin AL film layer 35 having thickness of the order of 0.1 μm, and the heat-resistant, thin metal layer 36 of e.g. Ta are made to adhere in order in the form of the anodizable, heat-resistant thin metal layer having thickness of the order of 0.1 μm, the low resistance wiring layer, and the anodizable intermediate conductive layer having thickness of the order of 0.1 μm, respectively, by use of the vacuum film forming device such as SPT. Then, these three metal layers are etched in order with the photosensitive resin pattern by use of the microfabrication technology, to selectively form the drain wire 21 and the signal wire 12, serving as the source wire as well, of the insulated gate transistor.

Sequentially, as shown in FIG. 16(d), the second and first amorphous silicon layers 33, 31 and the gate insulating layer 30 are selectively removed, except at least a region 102 in the neighborhood of the transistor forming region, to expose the glass substrate 2 In this process, the source/drain wires 12, 21 function as the mask, so that the second and first amorphous silicon layers 33, 31 and the gate insulating layer 30 at their parts located under the source/drain wires 12, 21 are not removed. Then, the anodized layer 71 is formed on the exposed scan line 11 and gate electrode 105 by anodic oxidation, or the organic insulating layer 71 is formed thereon by electrodeposition.

Sequentially, as shown in FIG. 16(e), ITO (Indium-Tin-Oxide) is made to adhere onto the glass substrate 2 in the form of the transparent conductive layer having thickness of the order of 0.1-0.2 μm by use of the vacuum film forming device, such as SPT (Sputtering system). Then, the pixel electrode 22 is selectively formed with the inclusion of a part of the drain wire 21 on the glass substrate 2 by use of the microfabrication technology. At the same time that the pixel electrode 22 is formed, the electrode terminals 6′ of the scan lines are formed with the inclusion of the exposed scan lines 11 in the regions other than the image display portion are formed. Then, with the photosensitive resin pattern 65 used for forming the selective pattern of the pixel electrode 22 as the mask, the source/drain wires 12, 21 are anodized under irradiation of light, to form the insulating layer thereon, and also the second amorphous silicon layer 33′ containing the impurities and first amorphous silicon layer 31′ containing no impurities as well exposed between the source/drain wires 12, 21 are partly anodized to form the silicon oxide layer 66, 67 of the insulating layers.

The Ta and the laminated Ta, AL and Ti are exposed at the top of the source/drain wires 12, 21 and at the side thereof, respectively. The tantalum pentoxide 68 of the insulating layer, the alumina 69 of the insulating layer and the titanium oxide 70 of the semiconductor are formed on the surfaces of the Ta, the AL and Ti, respectively, which are exposed by the anodic oxidation. The silicon oxide layer 66 and the silicon oxide layer 67, which are layers of oxide, are formed on the first amorphous silicon layer 33′ containing the impurities and the second amorphous silicon layer 31′ containing no impurities, respectively, which are exposed at the sides thereof under the source wire 12. The glass substrate 2 selective anodic oxidation, when practiced, enables a part of the signal wire 12 to be in the form of the electrode terminal 5 in the regions other than the image display portion, as shown in FIG. 15. Otherwise, the electrode terminal 5′ comprising the transparent conductive layer will be formed with the inclusion of a part of the signal wire 12 in the regions other than the image display portion, as separately illustrated. This constitution is identical to the connection form between the pixel electrode 22 and the drain wire 21 shown in FIG. 16(f). Finally, the photosensitive resin pattern 65 is removed to complete the active substrate 2, as shown in FIG. 16(f). The active substrate 2 thus produced and the color filter are laminated to produce the liquid crystal panel.

The storage capacity line 16 is easy to handle, as is the case with the scan line 11. While FIG. 8 illustrates an example of the constitution wherein the insulating layer 71 is formed on the exposed storage capacity line 16, so that the storage capacity 15 is formed by the storage capacity line 16 and the pixel electrode 22 by means of the insulating layer 71, alternatives are feasible, of course.

(Fifth Embodiment)

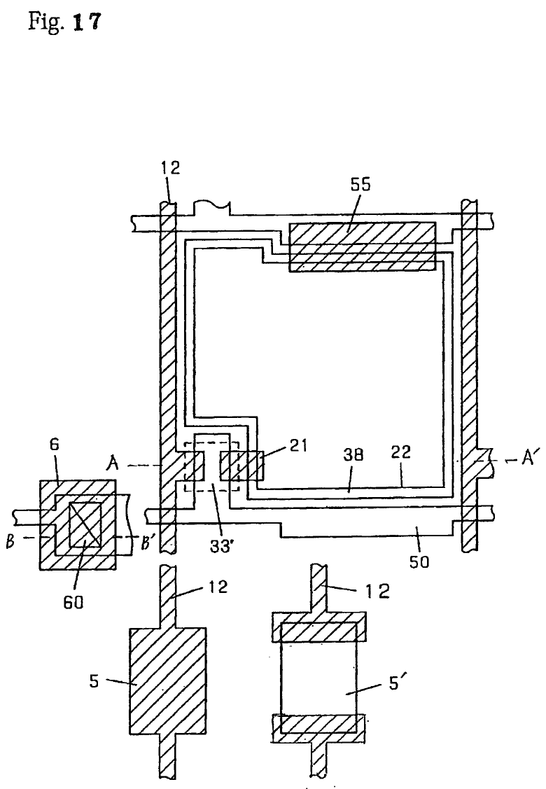

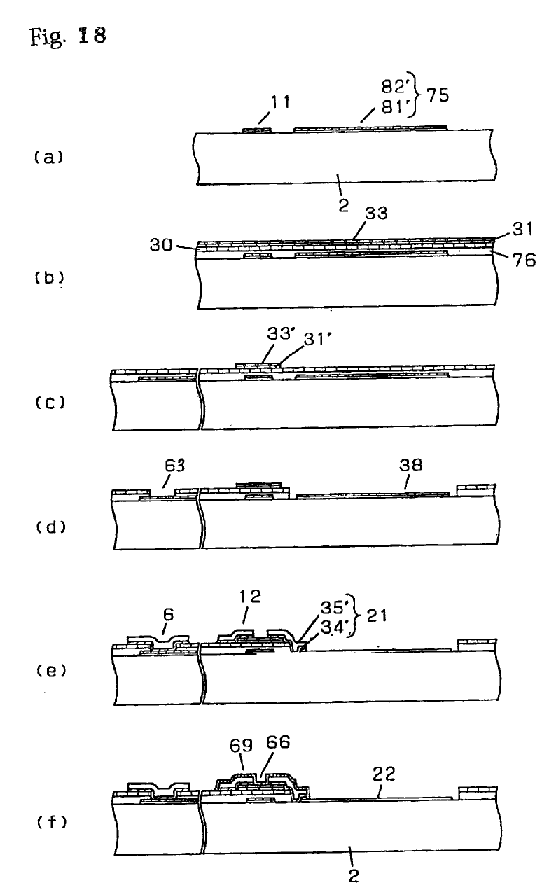

In this embodiment, the conventional island-shaped semiconductor layer forming process is kept intact, but the photo-lithography is tried to cut by forming the pixel electrode and the scan line simultaneously In the following, this embodiment will be described with reference to FIGS. 17 and 18.

In this embodiment (the production method of the active substrate according to the 18th aspect of the invention), as shown in FIG. 18(a), a transparent conductive layer 81 of e.g. ITO having thickness of the order of 0.1-0.2 μm, a first anodizable metal layer 82 having thickness of the order of 0.1-0.3 μm, and a single layer form of e.g. Ta or siliside such as Ta, Cr and Mo or a laminated layer form of e.g. AL/Ta and Ta/AL/Ta are made to adhere to one principal surface of the glass substrate 2 by use of the vacuum film forming device, such as SPT. Then, the gate electrode 11 and a pseudo pixel electrode 75 comprising a lamination of a transparent conductive layer 81′ and serving as the scan line, and a first metal layer 82′ as well are selectively formed by use of the microfabrication technology. Preferably, these electrodes are subjected to taper control to have a section produced by the dry etching, for providing improved dielectric breakdown between the electrodes and the signal wire by means of the gate insulating layer and thus providing an improved yield rate.

Then, as shown in FIG. 18(b), the transparent insulating layer of e.g. TaOₓ or SiO₂ is made to adhere in thickness of the order of 0.1 μm on the entire area of the glass substrate 2 in the form of a plasma protective layer 76. The plasma protective layer 76 is required for the transparent conductive layer 81′ exposed at edge portions of the gate electrode 11 and pseudo pixel electrode 75 to be reduced so as to vary the quantity of film of SiNₓ when the SiNₓ is formed in the sequential process using the PCVD device. Quod vide the prior art document of Japanese Laid-open Patent Publication No. Sho 59(1984)-9962 for the details thereof.

After the adhesion of the plasma protective layer 76, three thin film layers comprising the first SiNₓ (silicon nitride) layer 30 to form the gate insulating layer, the first amorphous silicon layer (a-Si) containing almost no impurities 31 to form the channel of the insulated gate transistor, and the second silicon layer containing the impurities 33 to form the source/drain of the insulated gate transistor are made to adhere in order, to have thickness of e.g. 0.3 μm, 0.1 μm and 0.05 μm, respectively, in the same manner as in the other embodiments.

Sequentially, as shown in FIG. 18(c), the gate insulating layer 30 is exposed to leave the semiconductor layer comprising the first and second amorphous silicon layers at portions thereof over and in the neighborhood of the gate electrode 11 in the island-shaped form 31′, 33′.

Sequentially, as shown in FIG. 18(d), in order that the opening 63 in the laminated insulating layer on the scan line 11 and the opening 38 to expose the pseudo pixel electrode 75 are formed around the image display portion required for electrical connection to the scan line 11, the second and first amorphous silicon layers 33, 31, the gate insulating layer 30 and plasma protective layer 76 are selectively removed.

Further, as shown in FIG. 18(e), the heat-resistant, thin metal film layer 34 made of e.g. Ti, Ta, and the thin AL film layer 35 having thickness of the order of 0.3 μm are made to adhere in order in the form of the heat-resistant metal layer having thickness of the order of 0.1 μm and the low resistance wiring layer, respectively, by use of the vacuum film forming device such as SPT. Then, these are processed by use of the microfabrication technology, to selectively form the source wire 12 of the insulated gate transistor, comprising a lamination of the heat-resistant thin metal layer 34′ and the low resistance wiring layer 35′ and serving as the signal wire as well, and the drain wire 21 (and the storage electrode 55) with the inclusion of a part of the pseudo pixel electrode 75. Further, with the photosensitive resin pattern used for forming the selective pattern as the mask, the first metal layer 82′ of the pseudo pixel electrodes 75 is removed to expose the transparent conductive layer 81′, so that the pixel electrode 22 is formed. At the same time that the source/drain wires 12, 21 are formed, the electrode terminals 6 of the scan lines are formed with the inclusion of the first metal layer 82′ exposed in the opening 63. Alternatively, the first metal layer 82′ exposed in the opening 63 may be formed as the electrode terminal.

Finally, as shown in FIG. 18(f), the source/drain wires 12, 21 are anodized under irradiation of light, to form the insulating layers 69, 70 (or 68) thereon, and also the second amorphous silicon layer 33′ containing the impurities and first amorphous silicon layer 31′ containing no impurities as were exposed between the source/drain wires 12, 21 are partly anodized to form the silicon oxide layers 66, 67 of the insulating layers. The glass substrate 2 selective anodic oxidation, when practiced, enables a part of the signal wire 12 to be in the form of the electrode terminal 5 in the regions other than the image display portion, as shown in FIG. 17. Otherwise, the signal wire 12 will be formed with the inclusion of a part of the electrode terminal 5′ comprising the transparent conductive layer through the metal layer 82′ in the regions other than the image display portion, as separately illustrated. This constitution is identical to the connection form between the pixel electrode 22 and the drain electrode 21 shown in FIG. 18(f). The active substrate 2 thus produced and the color filter are laminated to produce the liquid crystal panel.

In this embodiment, there is shown the constitution, as illustrated in FIG. 17, wherein the storage capacity 15 is formed by the projected portion 50 of the scan line 11 and the storage electrode 55 by means of gate insulating layer 30 and the plasma protective layer 76, and the storage electrode 55 is formed on the projected portion 50 with the inclusion of a part of the pixel electrode 22. As an alternative of the above constitution, the storage capacity 15 using the storage capacity line 16 is also feasible, but it is to be kept in mind that since the scan line 11 and the pixel electrode 22 are formed simultaneously, when a common capacity line 16 is arranged, the pixel electrode 22 is split into two high-and-low parts by the storage capacity line 16.

(Sixth Embodiment)

This embodiment relates to an improvement of the previous fifth embodiment.

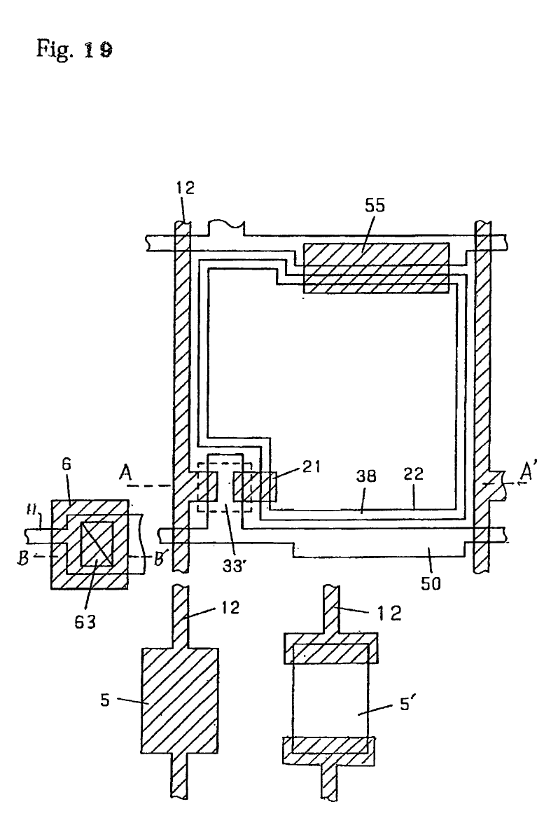

In the fifth embodiment, though the first metal layer 82′ of the pseudo pixel electrode 75 must be removed after the form of the source/drain wires 12, 21, since the amorphous silicon layer 33′ containing the impurities exists between the source/drain wires 12, 21, a selected ratio of that layer to the first metal layer 82′ is so critical that there is a high possibility that restraints may be imposed on the material of the first metal layer 82′. Accordingly, this embodiment aims to release such restrictions by a slight modification of the production process of the fifth embodiment. In the following, this embodiment will be described with reference to FIGS. 19 and 20.

In this embodiment (the production method of the active substrate according to the 19th aspect of the invention), the processes up to the process as shown in FIG. 20(d), in which in order that the opening 63 in the laminated insulating layer on the scan line 11 and the opening 38 to expose the pseudo pixel electrode 75 are formed around the image display portion required for electrical connection to the scan line 11, the second and first amorphous silicon layers 33, 31, the gate insulating layer 30 and plasma protective layer 76 are selectively removed, progress in the same production process as in the fifth embodiment.

Sequentially, the first metal layer 82′ is removed to expose the transparent conductive layer 81′ by use of the photosensitive resin pattern used for forming the selective pattern in this opening forming process. As a result of this, the transparent conductive pixel electrode 22 is formed in the opening 38.

Thereafter, the photosensitive resin pattern is removed. Then, as shown in FIG. 20(e), the heat-resistant, thin metal film layer 34 made of e.g. Ti, Ta, and the thin AL film layer 35 having thickness of the order of 0.3 μm are made to adhere in order in the form of the heat-resistant metal layer having thickness of the order of 0.1 μm and the low resistance wiring layer, respectively, by use of the vacuum film forming device such as SPT. Then, these are processed by use of the microfabrication technology, to selectively form the source wire 12 of the insulated gate transistor, comprising a lamination of the heat-resistant thin metal layer 34′ and the low resistance wiring layer 35′ and serving as the signal wire as well, and the drain wire 21 (and the storage electrode 55) with the inclusion of a part of the pixel electrode 22. At the same time that the source/drain wires 12, 21 are formed, the electrode terminals 6 of the scan lines are formed with the inclusion of the transparent conductive layer exposed in the opening 63.

Finally, as shown in FIG. 20(f), the source/drain wires 12, 21 are anodized under irradiation of light, to form the insulating layers 69, 70 (or 68) thereon, and also the second amorphous silicon layer 33′ containing the impurities and first amorphous silicon layer 31′ containing no impurities as well exposed between the source/drain wires 12, 21 are partly anodized to form the silicon oxide layers 66, 67 of the insulating layers. The active substrate 2 thus produced and the color filter are laminated to produce the liquid crystal panel.

(Seventh Embodiment)

In this embodiment, in addition to the process that the pixel electrode and the scan line are formed simultaneously, the island-shaped semiconductor layer forming process and the opening-in-the-gate-insulating-layer forming process are streamlined to further cut the production processes.

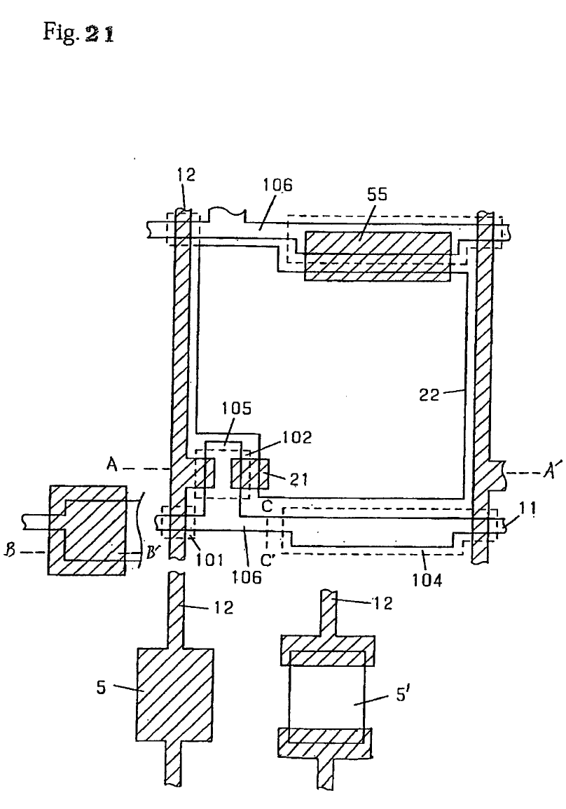

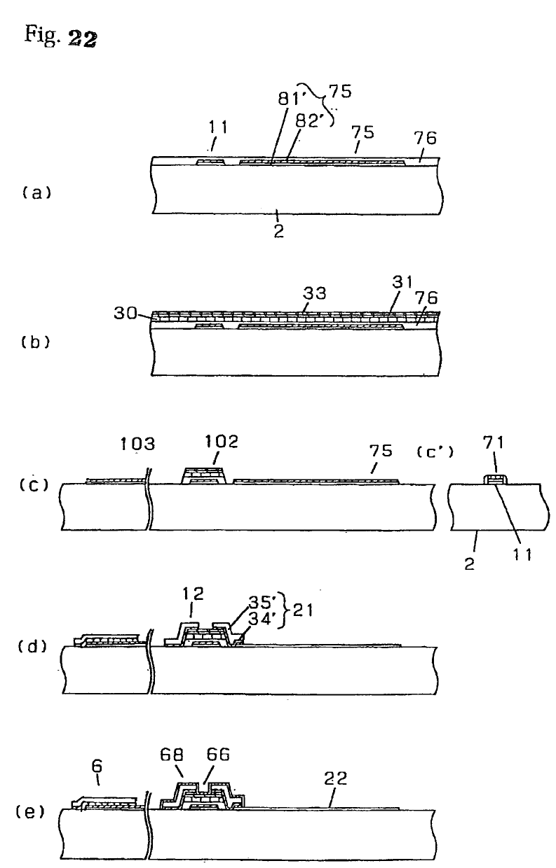

In the following, this embodiment will be described with reference to FIGS. 21 and 22. In this embodiment (the production method of the active substrate according to the 20th aspect of the invention), the processes up to the semiconductor layer film forming process shown in FIG. 22(b) progress in the same production process as in the fifth embodiment.

Thereafter, as shown in FIG. 22(c), except at least the transistor forming region 102 over and in the neighborhood of the gate electrode and the region 104 over and in the neighborhood of the scan line 11 to form the storage capacity, the second and first amorphous silicon layers 33, 31, the gate insulating layer 30, and the plasma protective layer 76 are etched to expose the glass substrate 2. Then, the anodized layer is formed on the exposed scan line 11 (106) and gate electrode 105 by anodic oxidation, or the organic insulating layer is formed thereon by electrodeposition. In this process, the pseudo pixel electrode 75 is isolated and is in electrical floating, so that the insulating layer 71 is not formed on the pseudo pixel electrode 75.

Sequentially, as shown in FIG. 22(d), the heat-resistant, thin metal film layer 34 made of e.g. Ti, Ta, and the thin AL film layer 35 having thickness of the order of 0.3 μm are made to adhere in order in the form of the heat-resistant metal layer having thickness of the order of 0.1 μm and the low resistance wiring layer, respectively, by use of the vacuum film forming device such as SPT. Then, these two metal layers are etched in order with the photosensitive resin pattern by use of the microfabrication technology, to selectively form the signal wire 12, serving as the source wire of the insulated gate transistor as well, and the drain wire 21 with the inclusion of a part of the pseudo pixel electrode 75. Further, with the photosensitive resin pattern used for forming the selective pattern as the mask, the first metal layer 82′ on the pseudo pixel electrode 75 is removed to expose the transparent conductive layer 81′, so as to form the pixel electrode 22.

Finally, as shown in FIG. 22(e), the source/drain wires 12, 21 are anodized under irradiation of light, to form the insulating layers 69, 70 (or 68) thereon, and also the second amorphous silicon layer 33′ containing the impurities and first amorphous silicon layer 31′ containing no impurities as well exposed between the source/drain wires 12, 21 are partly anodized to form the silicon oxide layers (SiO₂) 66, 67 of the insulating layers. The glass substrate 2 selective anodic oxidation, when practiced, enables a part of the signal wire 12 to be in the form of the electrode terminal 5 in the regions other than the image display portion, as shown in FIG. 19. Otherwise, the signal wire 12 will be formed with the inclusion of a part of the electrode terminal 5′ comprising the transparent conductive layer through the metal layer 82′ in the regions other than the image display portion, as separately illustrated. This constitution is identical to the connection form between the pixel electrode 22 and the drain wire 21 shown in FIG. 22(e). The active substrate 2 thus produced and the color filter are laminated to produce the liquid crystal panel.

(Eighth Embodiment)

This embodiment is an improvement of the previous seventh embodiment.

In the seventh embodiment, though the first metal layer 82′ of the pseudo pixel electrode 75 must be removed after the form of the source/drain wires 12, 21, since the amorphous silicon layer 33′ containing the impurities exists between the source/drain wires 12, 21, a selected ratio of that layer to the first metal layer 82′ is so critical that there is a high possibility that restraints may be imposed on the material of the first metal layer 82′, as is the case with the fifth embodiment. Accordingly, this eighth embodiment aims to release such restrictions by a slight modification of the production process of the seventh embodiment.

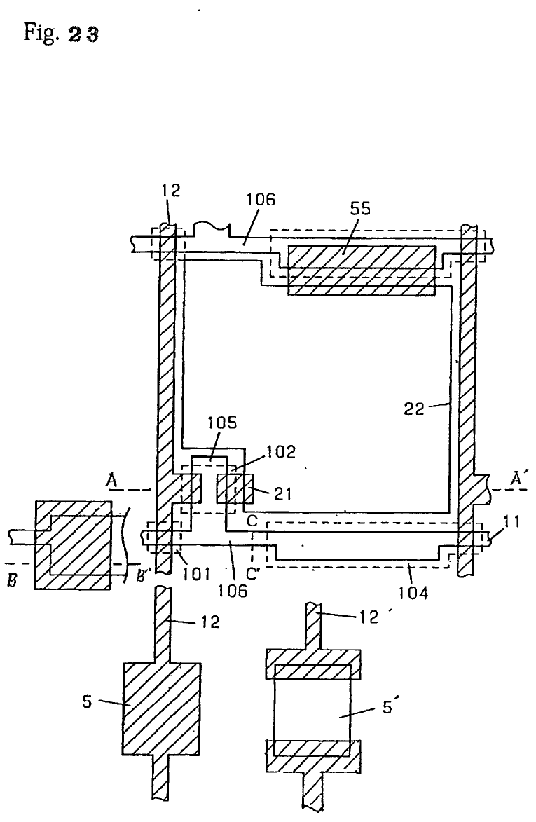

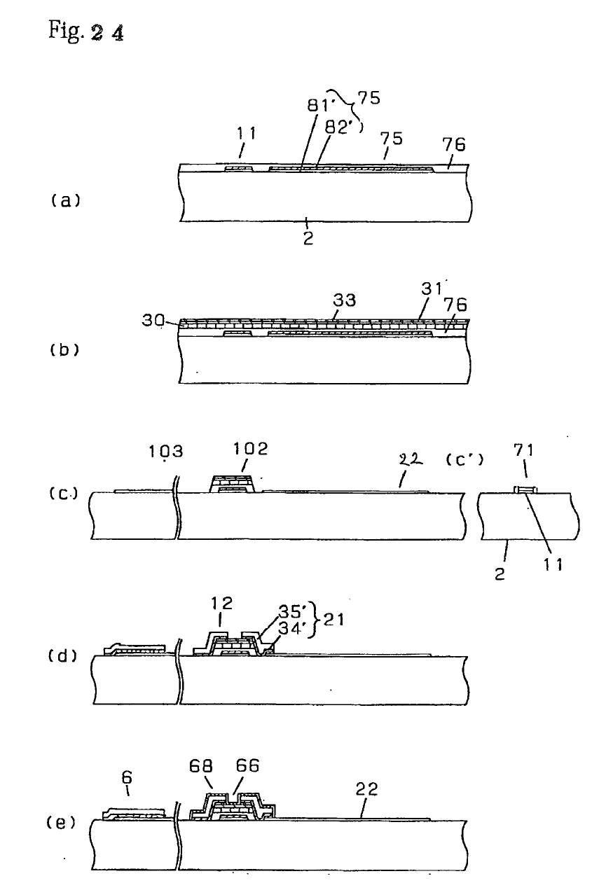

In the following, this embodiment will be described with reference to FIGS. 23 and 24. In this embodiment (the production method of the active substrate according to the 20th aspect of the invention), the processes up to the process as shown in FIG. 24(c), in which except at least the transistor forming region 102 over and in the neighborhood of the gate electrode and the region 104 over and in the neighborhood of the scan line 11 to form the storage capacity, the second and first amorphous silicon layers 33, 31, the gate insulating layer 30, and the plasma protective layer 76 are etched to expose the glass substrate 2, progress in the same production process as in the seventh embodiment. Sequentially, the first metal layer 82′ is removed by use of the photosensitive resin pattern used for the selective pattern forming, to expose the transparent conductive layer 81′. As a result of this, the transparent conductive pixel electrode 22 is formed on the insulating substrate 2.

Thereafter, the photosensitive resin pattern is removed and, then, the insulating layer is formed on the scan line 11 (106) and the gate electrode 105 as well exposed Since the first metal layer 82′ is already removed from the exposed scan line 11, only the transparent conductive layer is formed on the exposed scan line 11. In addition, even when the transparent conductive layer is anodized, it produces the anodized layer but does not produce any insulating layer, differently from the first metal layer 82′. Consequently, the organic insulating layer 71 is formed by electrodeposition. In this process, the pixel electrode 22 is isolated and is in electrical floating, so that the insulating layer 71 is not formed on the pixel electrode 22.

Sequentially, as shown in FIG. 24(d), the heat-resistant thin metal film layer 34 made of e.g. Ti, Ta, and the thin AL film layer 35 having thickness of the order of 0.3 μm are made to adhere in order in the form of the heat-resistant metal layer having thickness of the order of 0.1 μm and the low resistance wiring layer, respectively, by use of the vacuum film forming device such as SPT. Then, these two metal layers are etched in order with the photosensitive resin pattern by use of the microfabrication technology, to selectively form the signal wire 12, serving as the source wire of the insulated gate transistor as well, and the drain wire 21 with the inclusion of a part of the pixel electrode 22.

Finally, as shown in FIG. 24(e), the source/drain wires 12, 21 are anodized under irradiation of light, to form the insulating layers 69, 70 (or 68) thereon, and also the second amorphous silicon layer 33′ containing the impurities and first amorphous silicon layer 31′ containing no impurities as were exposed between the source/drain wires 12, 21 are partly anodized to form the silicon oxide layers 66, 67 of the insulating layers. The active substrate 2 thus produced and the color filter are laminated to produce the liquid crystal panel, to complete the eighth embodiment of the invention.

(Ninth Embodiment)

This embodiment is an application to a combined transmissive and reflective liquid crystal display and a reflective liquid crystal display.

In this embodiment, as a substitution of the transparent pixel electrode designated by 22 in FIG. 5, a semi-transmission-type pixel electrode (for the combined transmissive and reflective type) and a combined miller and pixel electrode (for the reflective type) are formed.

As the remaining constitution is substantially the same as the above-mentioned embodiments, the description thereon will be omitted.

While the present invention has been described with reference to several embodiments, it is needless to say that the present invention is not limited to the illustrated embodiments.

The key features of the present invention reside are that in the channel-etch-type insulated gate transistor, the surfaces of the source/drain wires as well as the amorphous silicon layer containing the impurities are anodized simultaneously by use of an anodizable source/drain wire material to change them to the insulating layers; and that a new insulating layer is formed on the surface of the exposed scan line by anodic oxidation or by electrodeposition. Other constitutions than those may be varied, such as, for example, varying quality, thickness and the like of material of the pixel electrode, the gate insulating layer and the like, varying the production method therefor, using a horizontal electric field system or IPS (In-Plain-Switching) system of liquid crystal panel, and using a reflective liquid crystal image display or a semi-transmission-type liquid crystal image display device having two kinds of pixel electrodes comprising a transparent electrode and a metal reflective electrode. Further, it is needless to say that the semiconductor layer of the insulated gate transistor is not limited to the amorphous silicon. Microcrystalline silicon, polycrystalline silicon and the like, or mixed crystal thereof are all included in the present invention.

### CAPABILITIES OF EXPLOITATION IN INDUSTRY

As seen from the description above, according to the present invention, since the silicon oxide layer containing the impurities for protecting the channel portion of the insulated gate transistor and the insulating layer, such as the tantalum pentoxide layer or the alumina layer, for protecting the source/drain wires are simultaneously formed by anodic oxidation, reduction in production process and in cost can be achieved.

In addition, since the passivation forming process does not involve any specific heating process, the insulated gate transistor using the amorphous silicon layer as the semiconductor layer is not required to have any excessive heat resistance, so that deterioration in electrical performance is not caused in the passivation forming process.

Also, since the insulating separation into a pair of amorphous silicon layers containing the impurities to form the source/drain of the insulated gate transistor is made by an electrochemical technique to modify the amorphous silicon layer containing the impurities by anodic oxidation, the amorphous silicon layer containing no impurities to form the channel can be reduced down to an optimum thickness to form the film layer, without any possibility that the electrical characteristics of the insulated gate transistor may be deteriorated by the wear and tear when the channel semiconductor layer is etched, differently from the prior art. This can provide significant improvement of the operating rate of the PCVD device and the particle generating condition.

Further, the island-shaped semiconductor forming process and the opening-in-the-gate-insulating-layer forming process are simultaneously performed via the process that the anodized layer of the scan line is formed on the exposed scan line by anodic oxidation or the organic insulating layer is formed thereon by electrodeposition, and also the pixel electrode and the scan line are formed simultaneously by introducing the pseudo pixel electrode. This can allow the number of photo-lithography processes to further reduce from 5 processes of the prior art to 4 or 3 processes, thus achieving production cost reduction.

1. An insulated gate transistor comprising:
a gate wire comprising at least one metal layer having an insulating layer on its surface exclusive of a gate electrode region in which a semiconductor is formed;
a first semiconductor layer containing no impurities which is formed on the gate electrode through at least one gate insulating layer;
a pair of second semiconductor layers containing impurities formed in such a relation that they are partly overlapped with the gate electrode to form a source region and a drain region;
a source wire and a drain wire formed by at least one anodizable metal layer having an anodized layer thereon with the inclusion of a source electrode and drain electrode portion of the pair of second semiconductor layers; and
a silicon oxide layer containing no impurities and a silicon oxide layer containing impurities which are formed on the first semiconductor layer between the source electrode and the drain electrode.

2. The insulated gate transistor according to claim 1, wherein the gate wire including the gate electrode comprises an anodizable metal layer, and an insulating layer formed thereon is the anodized layer.

3. The insulated gate transistor according to claim 1, wherein the insulating layer on the gate wire is an organic insulating layer.

4. An insulated gate transistor for a liquid crystal display having an insulating substrate in which unit pixels are arranged in two-dimensional matrix, the insulated gate transistor comprising:
a scan line comprising at least one metal layer and formed on the insulating substrate in succession to a gate electrode of the insulated gate transistor;
a gate electrode on which a lamination of at least one gate insulating layer and a first semiconductor layer containing no impurities, which is larger in width than a gate portion itself, is selectively formed;
an insulating layer formed on the other gate electrode and scan line;
a pair of second semiconductor layers containing impurities to form a source region and a drain region of the insulated gate transistor, which are formed on the first semiconductor layer on the gate electrode in such a relation that they are partly overlapped with each other:
a source wire (signal wire) and a drain wire formed on the pair of second semiconductor layers and the insulating substrate by at least one anodizable metal layer;
a transparent conductive pixel electrode formed on the insulating substrate with the inclusion of the drain wire;
an anodized layer formed on the source wire and drain wire exclusive of a pixel electrode on the drain wire; and
a silicon oxide layer containing no impurities and a silicon oxide layer containing impurities, which are formed on the first semiconductor layer between the source electrode and the drain electrode comprising the source wire and the drain wire, respectively.

5. An insulated gate transistor for a liquid crystal display having an insulating substrate in which unit pixels are arranged in two-dimensional matrix, the insulated gate transistor comprising:
a scan line and a connecting layer comprising at least one metal layer and formed on the insulating substrate in succession to a gate electrode of the insulated gate transistor;
a transparent conductive pixel electrode formed with the inclusion of a part of the connecting layer;
a gate electrode on which a lamination of at least one gate insulating layer and a first semiconductor layer containing no impurities, which is larger in width than a gate portion itself, is selectively formed;
an insulating layer formed on the other gate electrode and scan line;
a pair of second semiconductor layers containing impurities to form a source region and a drain region of the insulated gate transistor, which are formed on the first semiconductor layer on the gate electrode in such a relation that they are partly overlapped with the gate electrode;
a source wire (signal wire) and a drain wire formed with the inclusion of the connecting layer, which are formed on the pair of second semiconductor layers and the insulating substrate by at least one anodizable metal layer;
an anodized layer formed on the source wire and drain wire; and
a silicon oxide layer containing no impurities and a silicon oxide layer containing impurities, which are formed on the first semiconductor layer between the source wire and the drain wire.

6. An insulated gate transistor for a liquid crystal display having an insulating substrate in which unit pixels are arranged in two-dimensional matrix, the insulated gate transistor comprising:
a scan line comprising at least one metal layer and formed on the insulating substrate in succession to a gate electrode of the insulated gate transistor;
a transparent conductive pixel electrode;
a gate electrode on which a lamination of at least one gate insulating layer and a first semiconductor layer containing no impurities, which is larger in width than a gate portion itself, is selectively formed;
an insulating layer formed on the other gate electrode and scan line;
a pair of second semiconductor layers containing impurities to form a source region and a drain region of the insulated gate transistor, which are formed on the first semiconductor layer on the gate electrode in such a relation that they are partly overlapped with the gate;
a source wire (signal wire) formed on the pair of second semiconductor layers and the insulating substrate by at least one anodizable metal layer;
a drain wire formed with the inclusion of a part of the pixel electrode;
an anodized layer formed on the source wire and drain wire; and
a silicon oxide layer containing no impurities and a silicon oxide layer containing impurities, which are formed on the first semiconductor layer between the source wire and the drain wire.

7. An insulated gate transistor for a liquid crystal display having an insulating substrate in which unit pixels are arranged in two-dimensional matrix, the insulated gate transistor comprising:
a scan line comprising at least one metal layer and formed on the insulating substrate in succession to a gate electrode of the insulated gate transistor;
a gate electrode on which a lamination of at least one gate insulating layer and a first semiconductor layer containing no impurities, which is larger in width than a gate portion itself, is selectively formed;
an insulating layer formed on the other gate electrode and scan line;
a pair of second semiconductor layers containing impurities to form a source region and a drain region of the insulated gate transistor, which are formed on the first semiconductor layer on the gate electrode in such a relation that they are partly overlapped with the gate electrode;
a source wire (signal wire) and a drain wire formed on the pair of second semiconductor layers by at least one anodizable metal layer;
a transparent conductive pixel electrode formed on the insulating substrate with the inclusion of the drain wire;
an anodized layer formed on the source wire and drain wire, exclusive of a pixel electrode portion on the drain wire; and
a silicon oxide layer containing no impurities and a silicon oxide layer containing impurities, which are formed on the first semiconductor layer between the source wire and the drain wire.

8. An insulated gate transistor for a liquid crystal display having an insulating substrate in which unit pixels are arranged in two-dimensional matrix, the insulated gate transistor comprising:
a scan line which comprises a lamination of a transparent conductive layer and a metal layer formed on the insulating substrate and formed in succession to a gate electrode of the insulated gate transistor;
a transparent conductive pixel electrode on which the scan line and the metal layer is partly laminated;
a first semiconductor layer containing no impurities which is formed on the gate electrode through a plasma protective layer and a gate insulating layer to be larger in width than a gate portion itself;
a pair of second semiconductor layers containing impurities to form a source region and a drain region of the insulated gate transistor, which are formed on the first semiconductor layer in such a relation as to be partly overlapped with the gate electrode;
a source wire (signal wire) comprising at least one anodizable metal layer formed on the pair of second semiconductor layers and the gate insulating layer;
a drain wire formed with an inclusion of the laminated part with the transparent conductive pixel electrode;
an anodized layer formed on the source wire and drain wire; and
a silicon oxide layer containing no impurities and a silicon oxide layer containing impurities, which are formed on the first semiconductor layer between the source wire and the drain wire.

9. An insulated gate transistor for a liquid crystal display having an insulating substrate in which unit pixels are arranged in two-dimensional matrix, the insulated gate transistor comprising:
a scan line formed on the insulating substrate in succession to a gate electrode;
a transparent conductive pixel electrode;
a first semiconductor layer containing no impurities which is formed on the gate electrode through a plasma protective layer and a gate insulating layer to be larger in width than a gate portion itself,
a pair of second semiconductor layers containing impurities to form a source region and a drain region of the insulated gate transistor, which are formed on the first semiconductor layer in such a relation as to be partly overlapped with the gate electrode;
a source wire (signal wire) comprising at least one anodizable metal layer formed on the pair of second semiconductor layers and the gate insulating layer;
a drain wire formed with an inclusion of the transparent conductive pixel electrode;
an anodized layer formed on the source wire and drain wire;
a silicon oxide layer containing no impurities and a silicon oxide layer containing impurities, which are formed on the first semiconductor layer between the source and drain wires.

10. An insulated gate transistor for a liquid crystal display having an insulating substrate in which unit pixels are arranged in two-dimensional matrix, the insulated gate transistor comprising:
a scan line which comprises a lamination of a transparent conductive layer and an anodizable metal layer formed on the insulating substrate and is formed in succession to a gate electrode of the insulated gate transistor;
a transparent conductive pixel electrode formed in such a relation as to be partly laminated on the metal layer;
a plasma protective layer and a gate insulating layer which are formed to be larger in width than a gate portion itself;
a first semiconductor layer containing no impurities which is formed on the gate electrode;
an insulating layer formed on the other scan line and gate electrode;
a pair of second semiconductor layers containing impurities to form a source region and a drain region of the insulated gate transistor, which are formed on the first semiconductor layer on the gate electrode in such a relation as to be partly overlapped with the gate electrode;
a source wire (signal wire) comprising at least one anodizable metal layer formed on the pair of second semiconductor layers and the insulating substrate;
a drain wire formed in lamination with the metal layer of the transparent conductive pixel electrode; and
a silicon oxide layer containing no impurities and a silicon oxide layer containing impurities, which are formed on the first semiconductor layer between the source wire and drain wire.

11. An insulated gate transistor for a liquid crystal display having an insulating substrate in which unit pixels are arranged in two-dimensional matrix, the insulated gate transistor comprising:
a scan line which comprises a lamination of a transparent conductive layer and a metal layer and is formed on the insulating substrate in succession to a gate electrode of the insulated gate transistor;
a transparent conductive pixel electrode;
a gate insulating layer formed on a plasma protective layer to be larger in width than a gate portion itself;
a first semiconductor layer containing no impurities which is formed on the gate insulating later;
an insulating layer formed on the other scan line and gate electrode;
a pair of second semiconductor layers containing impurities to form a source region and a drain region of the insulated gate transistor, which are formed on the first semiconductor layer on the gate electrode in such a relation as to be partly overlapped with the gate electrode;
a source wire (signal wire) comprising at least one anodizable metal layer formed on the pair of second semiconductor layers and the gate insulating layer;
a drain wire formed with an inclusion of the pixel electrode;
an anodized layer formed on the source wire and drain wire;
a silicon oxide layer containing no impurities and a silicon oxide layer containing impurities, which are formed on the first semiconductor layer between the source wire and drain wire.

12. The insulated gate transistor for a liquid crystal display according to any one of claims 4, 5, 6, 7 and 10, wherein the gate electrode comprises an anodizable metal layer, and an insulating layer formed thereon is an anodized layer.

13. The insulated gate transistor for a liquid crystal display according to any one of claims 4, 5, 6, 7, 10 and 11, wherein the insulating layer is an organic insulating layer.

14. A production method of an insulated gate transistor for a liquid crystal display comprising:
the gate wire and equivalent forming step that a scan line, which comprises at least one metal layer, and a part of which serves as a gate electrode of the insulated gate transistor as well, is formed on an insulating substrate;
the sequentially laminating step combined with the gate portion and equivalent forming step that at least one gate insulating layer, a first amorphous silicon layer containing no impurities, and a second amorphous silicon layer containing impurities are allowed to adhere in order;
the substrate exposing step that the insulating substrate is exposed by selectively leaving the second and first amorphous silicon layers and the gate insulating layer, which were formed in the above step, in at least a transistor forming region;
the insulating layer forming step that an insulating layer is formed on at least the scan line and gate electrode which are exposed in an image display portion;
the wire forming step that after at least one anodizable metal layer is allowed to adhere, a source wire (signal wire), formed with an inclusion of the second amorphous silicon layer to be partly overlapped with the gate electrode, and a drain wire are formed on the insulating substrate;
the pixel electrode forming step that a transparent conductive pixel electrode is formed on the insulating substrate with the inclusion of the drain wire formed in the above step; and
the photomask used silicon anodic oxidation step that in the condition that a photosensitive resin pattern used for forming a selective pattern of the pixel electrode is used as a mask to protect the pixel electrode, the source wire, the drain wire, all of the second amorphous silicon layer between the source wire and the drain wire, and a part of the first amorphous silicon layer therebetween are anodized under irradiation of light.

15. A production method of an insulated gate transistor for a liquid crystal display comprising:
the gate wire and equivalent forming step that a scan line, which comprises at least one metal layer, and a part of which serves as a gate electrode of the insulated gate transistor as well, and a connecting layer are formed on an insulating substrate;
the sequentially laminating step combined with the gate portion and equivalent forming step that at least one gate insulating layer, a first amorphous silicon layer containing no impurities, and a second amorphous silicon layer containing impurities are allowed to adhere in order;
the substrate exposing step that the insulating substrate is exposed by selectively leaving the second and first amorphous silicon layers and the gate insulating layer, which were formed in the above step, in at least a transistor forming region;
the insulating layer forming step that an insulating layer is formed on at least the scan line and gate electrode which are exposed in an image display portion;
the wire forming step that after at least one anodizable metal layer is allowed to adhere, a source wire (signal wire), formed with an inclusion of the second amorphous silicon layer to be partly overlapped with the gate electrode, and a drain wire, formed with the inclusion of a part of the connecting layer, are formed on the insulating substrate;
the pixel electrode forming step that a transparent conductive pixel electrode is formed on the insulating substrate with the inclusion of a part of the connecting layer; and
the photomask used silicon anodic oxidation step that in the condition that a photosensitive resin pattern used for forming a selective pattern of the pixel electrode is used as a mask to protect the pixel electrode, the source wire, the drain wire, all of the second amorphous silicon layer between the source wire and the drain wire, and a part of the first amorphous silicon layer therebetween are anodized under irradiation of light.

16. A production method of an insulated gate transistor for a liquid crystal display comprising:
the gate wire and equivalent forming step that a scan line, which comprises at least one metal layer and serves as a gate electrode of the insulated gate transistor as well, is formed on an insulating substrate;
the gate portion and equivalent forming sequential laminating step that at least one gate insulating layer, a first amorphous silicon layer containing no impurities, and a second amorphous silicon layer containing impurities are allowed to adhere in order;
the substrate exposing step that the insulating substrate is exposed by selectively leaving the second and first amorphous silicon layers and the gate insulating layer, which were formed in the above step, in at least a transistor forming region;
the insulating layer forming step that an insulating layer is formed on at least the scan line and gate electrode which are exposed in an image display portion;
the pixel electrode forming step that a transparent conductive pixel electrode is formed on the insulating substrate;
the wire forming step that after at least one anodizable metal layer is allowed to adhere, a source wire (signal wire), formed with an inclusion of the second amorphous silicon layer to be partly overlapped with the gate electrode, and a drain wire, formed with the inclusion of a part of the pixel electrode, are formed on the insulating substrate;
the photomask used silicon anodic oxidation step that the source wire, the drain wire, all of the second amorphous silicon layer between the source wire and the drain wire, and a part of the first amorphous silicon layer therebetween are anodized under irradiation of light.

17. A production method of an insulated gate transistor for a liquid crystal display comprising:
the gate wire and equivalent forming step that a scan line, which comprises at least one metal layer, and a part of which serves as a gate electrode of the insulated gate transistor as well, is formed on an insulating substrate;
the gate portion and equivalent forming sequential laminating step that at least one gate insulating layer, a first amorphous silicon layer containing no impurities, and a second amorphous silicon layer containing impurities are allowed to adhere in order;
the wire forming step that after at least one anodizable metal layer is allowed to adhere, a source wire (signal wire) and a drain wire are formed on the second amorphous silicon layer, to be partly overlapped with the gate electrode;
the substrate exposing step that the insulating substrate is exposed by selectively leaving the second and first amorphous silicon layers and the gate insulating layer in a region under the source wire and drain wire formed in the above process and in a transistor forming region;
the insulating layer forming step that an insulating layer is formed on at least the scan line and gate electrode which are exposed in an image display portion;
the pixel electrode forming step that a transparent conductive pixel electrode is formed on the insulating substrate with the inclusion of the drain wire; and
the photomask used silicon anodic oxidation step that in the condition that a photosensitive resin pattern used for forming a selective pattern of the pixel electrode is used as a mask to protect the pixel electrode, the source wire, the drain wire, all of the second amorphous silicon layer between the source wire and the drain wire, and a part of the first amorphous silicon layer therebetween are anodized under irradiation of light.

18. A production method of an insulated gate transistor for a liquid crystal display comprising:
the gate wire and equivalent forming step that a scan line, which comprises a lamination of a transparent conductive layer and a metal layer, and a part of which serves as a gate electrode of the insulated gate transistor as well, and a pseudo pixel electrode are formed on an insulating substrate;
the gate portion and equivalent forming sequential laminating step that a plasma protective layer, a gate insulating layer, a first amorphous silicon layer containing no impurities, and a second amorphous silicon layer containing impurities are allowed to adhere in order;
the gate insulating film exposing step that the gate insulating layer is exposed by selectively leaving the second and first amorphous silicon layers in at least a transistor forming region;
the pseudo pixel electrode exposing step that the pseudo pixel electrode is exposed by removing the gate insulating layer and plasma protective layer on the pseudo pixel electrode;
the source wire and drain wire forming step that after at least one anodizable metal layer is allowed to adhere, a source wire (signal wire), formed with an inclusion of the second amorphous silicon layer to be partly overlapped with the gate electrode, and a drain wire, formed with the inclusion of a part of the pseudo pixel electrode, are formed on the gate insulating substrate;
the pseudo pixel electrode exposing step that the metal layer formed on the pseudo pixel electrode formed in the above step is removed; and
the light used silicon anodic oxidation step that the source wire, the drain wire, all of the second amorphous silicon layer between the source wire and the drain wire, and a part of the first amorphous silicon layer therebetween are anodized under irradiation of light.

19. A production method of an insulated gate transistor for a liquid crystal display comprising:
the gate wire and equivalent forming step that a scan line, which comprises a lamination of a transparent conductive layer and a metal layer, and a part of which serves as a gate electrode of the insulated gate transistor as well, and a pseudo pixel electrode are formed on an insulating substrate;
the gate portion and equivalent forming sequential laminating step that a plasma protective layer, a gate insulating layer, a first amorphous silicon layer containing no impurities, and a second amorphous silicon layer containing impurities are allowed to adhere in order;
the gate insulating film exposing step that the gate insulating layer is exposed by selectively leaving the second and first amorphous silicon layers in at least a transistor forming region;
the pseudo pixel electrode exposing step that the pseudo pixel electrode is exposed by removing the gate insulating layer and plasma protective layer on the pseudo pixel electrode;
the metal layer removing step that the metal layer formed on he pseudo pixel electrode is removed;
the source wire and drain wire forming step that after at least one anodizable metal layer is allowed to adhere, a source wire (signal wire), formed with an inclusion of the second amorphous silicon layer to be partly overlapped with the gate electrode, and a drain wire, formed with the inclusion of a part of the pixel electrode, are formed on the gate insulating substrate; and
the light used silicon anodic oxidation step that the source wire, the drain wire, all of the second amorphous silicon layer between the source wire and the drain wire, and a part of the first amorphous silicon layer therebetween are anodized under irradiation of light.

20. A production method of an insulated gate transistor for a liquid crystal display comprising:
the gate wire and equivalent forming step that a scan line, which comprises a lamination of a transparent conductive layer and a metal layer, and a part of which serves as a gate electrode of the insulated gate transistor as well, and a pseudo pixel electrode are formed on an insulating substrate;
the gate portion and equivalent forming sequential laminating step that a plasma protective layer, a gate insulating layer, a first amorphous silicon layer containing no impurities, and a second amorphous silicon layer containing impurities are allowed to adhere in order;
the substrate exposing step that the insulating substrate is exposed by selectively leaving the second and first amorphous silicon layers, the gate insulating layer and the plasma protective layer in at least a transistor forming region;
the insulating layer forming step that an insulating layer is formed on the scan layer and gate electrode exposed in at least an image display region;
the source wire and drain wire forming step that after at least one anodizable metal layer is allowed to adhere, a source wire (signal wire), formed with an inclusion of the second amorphous silicon layer to be partly overlapped with the gate electrode, and a drain wire, formed with the inclusion of a part of the pseudo pixel electrode, are formed on the insulating substrate;
the metal layer removing step that the metal layer formed on the pseudo pixel electrode is removed; and
the light used silicon anodic oxidation step that the source wire, the drain wire, all of the second amorphous silicon layer between the source wire and the drain wire, and a part of the first amorphous silicon layer therebetween are anodized under irradiation of light.

21. A production method of an insulated gate transistor for a liquid crystal display comprising:
the gate wire and equivalent forming step that a scan line, which comprises a lamination of a transparent conductive layer and a metal layer, and a part of which serves as a gate electrode of the insulated gate transistor as well, and a pseudo pixel electrode are formed on an insulating substrate;
the gate portion and equivalent forming sequential laminating step that a plasma protective layer, a gate insulating layer, a first amorphous silicon layer containing no impurities, and a second amorphous silicon layer containing impurities are allowed to adhere in order;
the substrate exposing step that the insulating substrate is exposed by selectively leaving the second and first amorphous silicon layers, the gate insulating layer and the plasma protective layer in at least a transistor forming region;
the metal layer removing step that the metal layer formed on the pseudo pixel electrode is removed;
the insulating layer forming step that an insulating layer is formed on the scan line and gate electrode exposed in at least an image display region;
the source wire and drain wire forming step that after at least one anodizable metal layer is allowed to adhere, a source wire (signal wire), formed with an inclusion of the second amorphous silicon layer to be partly overlapped with the gate electrode, and a drain wire, formed with the inclusion of a part of the pixel electrode, are formed on the insulating substrate; and
the light used silicon anodic oxidation step that the source wire, the drain wire, all of the second amorphous silicon layer between the source wire and the drain wire, and a part of the first amorphous silicon layer therebetween are anodized under irradiation of light.

22. The production method of an insulated gate transistor for a liquid crystal display according to any one of claims 14, 15, 16, 17 and 20, which includes the gate electrode metal selecting step that prior to the gate wire and equivalent forming step, the anodizable metal layer is selected as the gate electrode, and wherein the insulating layer forming step is the anodized film insulating layer forming step that the insulating layer is formed by anodic oxidation.

23. The production method of an insulated gate transistor for a liquid crystal display according to any one of claims 14, 15, 16, 17, 20 and 21, wherein the insulating layer forming step is the electrodeposition use insulating layer forming step that the insulating layer is formed by an organic insulating material is allowed to adhere by electrodeposition.

24. The insulated gate transistor for a liquid crystal display according to any one of claims 4 through 11, wherein the liquid crystal display is a combined transmissive and refelective liquid crystal display, and wherein the transparent conductive pixel electrode is a semi-transmissive and semi-conductive, pixel electrode.

25. The insulated gate transistor for a liquid crystal display according to any one of claims 4 through 11, wherein the liquid crystal display is a refelective liquid crystal display, and wherein a conductive miller is used as a substitution of the transparent conductive pixel electrode.

26. The insulated gate transistor for a liquid crystal display according to any one of claims 4 through 11, wherein the liquid crystal display is a refelective liquid crystal display, and wherein the insulating substrate has a miller and a transparent insulating layer which are formed in at least a region immediately under the transparent conductive pixel electrode.

27. The insulated gate transistor for a liquid crystal display according to any one of claims 24, 25 and 26, wherein the gate electrode comprises an anodizable metal layer and further its insulating layer is an anodized layer.

28. The insulated gate transistor for a liquid crystal display according to any one of claims 24, 25 and 26, wherein the insulating layer is an organic insulating layer.
